(19) United States
(12) Patent Application Publication
(10) Pub. No.: US 2020/0322518 A1
(43) Pub. Date: Oct. 8, 2020

(54) INFORMATION PROCESSING APPARATUS, INFORMATION PROCESSING METHOD, AND PROGRAM

(71) Applicant: SONY CORPORATION

(72) Inventor: MASAHARU NAGATA, TOKYO (JP)

(21) Appl. No.: 16/305,346

(22) PCT Filed: May 29, 2017
(86) PCT No.: PCT/JP2017/019832

§ 371 Date: Nov. 28, 2018

(30) Foreign Application Priority Data
Jun. 10, 2016 (JP) 2016-116167

(51) Int. Cl. H04N 5/235; H04N 5/232

(52) U.S. Cl. CPC H04N 5/2353; G03B 7/093; H04N 5/23216; H04N 5/23218

(57) ABSTRACT

The present technology relates an information processing apparatus, an information processing method, and a program which realize acquirement of an image corresponding to a user's action. The information processing apparatus includes an image capture control unit. The image capture control unit controls an image capture parameter of an image capture unit mounted on a user on the basis of a recognition result of the user's action. The present technology is applicable to, for example, various wearable terminals such as an eyeglass type, a head band type, a pendant type, a ring type, a contact lens type, a shoulder mounting type, and a head mount display, various portable terminals such as a smartphone, a camera platform, a control server, and the like.

### TECHNICAL FIELD

The present technology relates to an information processing apparatus, an information processing method, and a program, and more particularly, to an information processing apparatus, an information processing method, and a program which are capable of acquiring an appropriate image in correspondence with a user's action.

### BACKGROUND ART

In the related art, there is suggested a wearable terminal in which an image capture operation is executed in a case where an output of a gyro sensor or an acceleration sensor is equal to or less than a predetermined threshold value, and the image capture operation is prohibited in a case where the output is greater than the predetermined threshold value (for example, refer to Patent Document 1).

### CITATION LIST

### Patent Document

### Patent Document 1: Japanese Patent Application Laid-Open No. 2015-159383

### SUMMARY OF THE INVENTION

### Problems to be Solved by the Invention

However, in the wearable terminal that is described in Patent Document 1, the image capture operation is prohibited in a case where a user does not stop, and thus an image cannot be acquired, for example, when the user walks, runs, or rides on a bicycle.

The present technology has been made in consideration of the above-described circumstances, and an object thereof is to realize acquirement of an image corresponding to a user's action.

### Solutions to Problems

An information processing apparatus of one aspect of the present technology includes: an image capture control unit that controls an image capture parameter of an image capture unit mounted on a user on the basis of a recognition result of an action of the user.

The image capture parameter may be allowed to include at least one of a parameter related to an operation of an imaging element of the image capture unit, and a parameter related to processing of a signal from the imaging element.

The parameter related to the operation of the imaging element may be allowed to include at least one of a shutter speed or an image capture timing, and the parameter related to processing of the signal from the imaging element may be allowed to include at least one of sensitivity or a camera shake correction range.

The image capture control unit may be allowed to control at least one of the shutter speed, the sensitivity, or the camera shake correction range on the basis of a movement speed of the user and vibration.

In a case where the user rides on a predetermined transport, the image capture control unit may be allowed to make the shutter speed slower and make the sensitivity lower when capturing an advancing direction, in comparison to a case where the advancing direction is not captured.

The image capture control unit may be allowed to control the shutter speed and the sensitivity when capturing a still image, and control the sensitivity and the camera shake correction range when capturing a moving image.

The image capture control unit may be allowed to perform control so that image-capturing is performed in a case where the user takes a predetermined action.

The image capture control unit may be allowed to control an image capture timing on the basis of biological information of the user.

The image capture control unit may be allowed to switch a state in which a lens of the image capture unit is seen from the outside and a state in which the lens is not seen from the outside on the basis of the recognition result of the action of the user.

The image capture control unit may be allowed to perform control so that image-capturing is performed at an interval based on at least one of time, a movement distance of the user, or an altitude of a location of the user.

The image capture control unit may be allowed to select whether to perform image-capturing at an interval based on the time or to perform image-capturing at an interval based on the movement distance of the user on the basis of a movement speed of the user.

The image capture control unit may be allowed to control the image capture parameter in cooperation with another information processing apparatus.

The image capture control unit may be allowed to change a method of controlling the image capture parameter in accordance with a mounting position of the image capture unit.

In a case where the action of the user varies, the image capture control unit may be allowed to change the image capture parameter after the action of the user after variation continues for a predetermined time.

In a case where the action of the user varies, the image capture control unit may be allowed to change the image capture parameter step by step.

The image capture control unit may be allowed to control the image capture parameter on the basis of a surrounding environment.

The action of the user that is recognized may be allowed to include at least one of in riding in a car, in riding on a motorbike, in riding on a bicycle, in running, in walking, in riding on a train, and in stopping.

An action recognition unit that recognizes the action of the user on the basis of one or more of detection results of a current position, a movement speed, vibration, and a posture of the user may further be provided.

An information processing method of one aspect of the present technology includes: an image capture control step of controlling image capture parameter of an image capture unit mounted on a user by an information processing apparatus on the basis of a recognition result of an action of the user.

A program of one aspect of the present technology allows a computer to execute: an image capture control step of controlling image capture parameter of an image capture unit mounted on a user on the basis of a recognition result of an action of the user.

According to one aspect of the present technology, an image capture parameter of the image capture unit mounted on a user is controlled on the basis of a recognition result of an action of the user.

### Effects of the Invention

According to the present technology, it is possible to acquire an image corresponding to a user's action.

Furthermore, the effect described here is not limited, and may be any one effect described in this disclosure.

### BRIEF DESCRIPTION OF DRAWINGS

FIG. 1 is a view illustrating a configuration example of an external appearance of an information processing terminal according to an embodiment of the present technology.

FIG. 2 is a view illustrating amounting example of the information processing terminal.

FIG. 3 is an enlarged view of a tip end of a right unit.

FIG. 4 is a view illustrating an image capture angle.

FIG. 5 is an enlarged view of the tip end of the right unit.

FIG. 6 is a view illustrating the external appearance of the information processing terminal.

FIG. 7 is a view illustrating the external appearance of the information processing terminal.

FIG. 8 is a perspective view illustrating the external appearance of the information processing terminal.

FIG. 9 is a view illustrating a structure of a camera block.

FIG. 10 is a perspective view illustrating the structure of the camera block.

FIG. 11 is a block diagram illustrating an inner configuration example of the information processing terminal.

FIG. 12 is a block diagram illustrating a functional configuration example of the information processing terminal.

FIG. 13 is a view illustrating an example of an image capture mode.

FIG. 14 is a flowchart illustrating image capture processing of the information processing terminal.

FIG. 15 is a flowchart illustrating details of still image capture processing.

FIG. 16 is a view illustrating an example of an image capture parameter setting method.

FIG. 17 is a flowchart illustrating details of still image continuous shooting processing.

FIG. 18 is a flowchart illustrating details of interval image capture processing.

FIG. 19 is a view illustrating an example of a detail mode of the interval image capture mode.

FIG. 20 is a flowchart illustrating details of auto image capture processing.

FIG. 21 is a view illustrating an example of a detail mode of the auto image capture mode.

FIG. 22 is a flowchart illustrating details of moving image capture processing.

FIG. 23 is a view illustrating an example of a control system.

FIG. 24 is a view illustrating another example of the control system.

FIG. 25 is a view illustrating an example of a shape of the information processing terminal.

FIG. 26 is a view illustrating an example of a camera platform.

FIG. 27 is a block diagram illustrating a configuration example of a computer.

### MODE FOR CARRYING OUT THE INVENTION

Hereinafter, modes for carrying out the present technology will be described. Description will be made in the following order.

1. External Appearance of Information Processing Terminal

2. Structure of Camera Block

3. Internal Configuration of Information Processing Terminal

4. Processing of Information Processing Terminal

5. Modification Example

6. Others

### 1. External Appearance of Information Processing Terminal

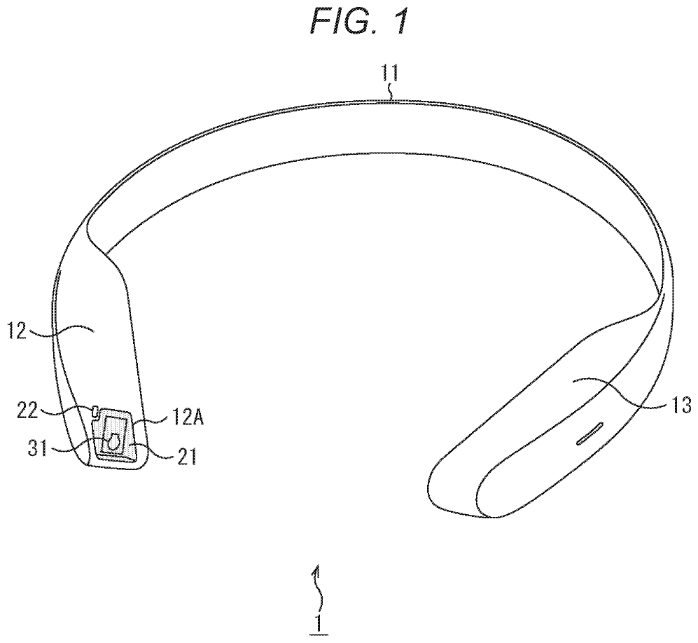

FIG. 1 is a view illustrating a configuration example of an external appearance of an information processing terminal according to an embodiment of the present technology.

As illustrated in FIG. 1, on the whole, an information processing terminal 1 is a wearable terminal having an approximately C-shaped external appearance in a front view. The information processing terminal 1 includes a right unit 12 and a left unit 13 which are provided on inner sides near right and left tip ends of a band unit 11 that is obtained by curving a thin plate-shaped member.

The right unit 12 illustrated on the left side of FIG. 1 includes a casing having a width larger than the thickness of the band unit 11 in a front view, and is formed to swell from an inner surface of the band unit 11.

On the other hand, the left unit 13 illustrated on the right side has a shape that is approximately symmetrical to a shape of the right unit 12 with a front opening of the band unit 11 interposed therebetween. As in the right unit 12, the left unit 13 includes a casing having a width larger than the thickness of the band unit 11 in a front view, and is formed to swell from an inner surface of the band unit 11.

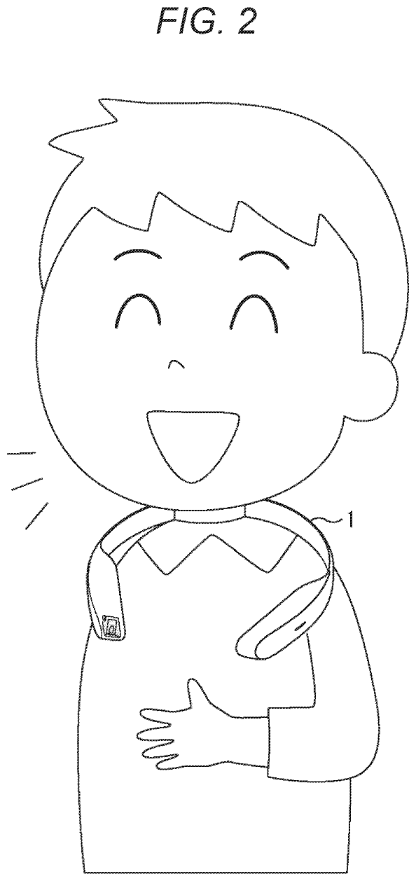

For example, the information processing terminal 1 having the above-described external appearance is mounted to be hung on the neck as illustrated in FIG. 2. In mounting, an inner side of the deepest portion of the band unit 11 comes into contact with the neck of a user, and the information processing terminal 1 takes a posture inclined to a front side. When seen from the user, the right unit 12 is located on the right of a throat of the user, and the left unit 13 is located on the left of the throat of the user.

As will be described later, the information processing terminal 1 has functions such as an image capture function, a music reproducing function, a radio communication function, and a sensing function.

In a state in which the information processing terminal 1 is mounted, the user can execute the functions by operating a button provided in the right unit 12, for example, with a right hand, and by operating a button provided in the left unit 13, for example, with a left hand. In addition, the information processing terminal 1 is also provided with a voice recognition function. The user can also operate the information processing terminal 1 with speech.

Music output from a speaker that is provided in the right unit 12 by the music reproducing function of the information processing terminal 1 mainly reaches a right ear of the user, and music output from a speaker that is provide in the left unit 13 mainly reaches a left ear of the user.

The user wears the information processing terminal 1, and can run or rides on a bicycle while listening to music. Various kinds of voices such as news acquired from a network may be output instead of the music.

As described above, for example, the information processing terminal 1 is a terminal that is assumed to be used in light exercise. Ears are not clogged with a phone and the like, and thus the user can hear a surrounding sound with music output from the speakers.

In addition, for example, the information processing terminal 1 can record a life log of the user by recording sensing data and the like in a state of being constantly mounted on the user.

Returning to description of FIG. 1, a curved surface that is an arc surface shape is formed on tip ends of the right unit 12 and the left unit 13. An approximately rectangular opening 12A, which is long in a vertical direction, is formed in the tip end of the right unit 12 from a position near a forward side of an upper surface to a position near an upward side of the curved surface of the tip end. The opening 12A has a shape in which an upper-left corner is depressed, and a light emitting diode (LED) 22 is provided at the depressed position.

A transparent cover 21 including, for example, an acryl is inserted into opening 12A. A surface of the cover 21 forms a curved surface having approximately the same radius of curvature as that of the curved surface of the tip end of the left unit 13. A lens 31 of a camera module provided at the inside of the right unit 12 is provided in the cover 21. An image capture direction of the camera module is a front side of the user when seen from the user who wears the information processing terminal 1.

For example, the user wears the information processing terminal 1, and can capture a forward landscape as a moving image or a still image, while running, or riding on a bicycle with listening to music, as described above. In addition, the user can perform the image-capturing in a hands-free manner by a voice command to be described later in detail.

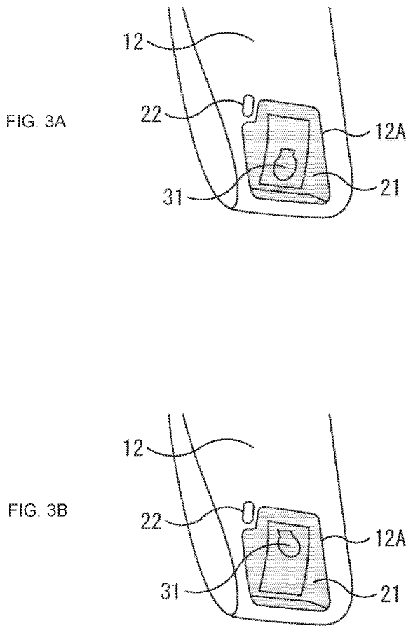

FIG. 3 is a view illustrating the tip end of the right unit 12 in an enlarged manner.

As illustrated in A of FIG. 3 and B of FIG. 3, the information processing terminal 1 can control an image angle (image capture range) of an image to be captured by changing an angle of the lens 31 in an upper and lower direction. A of FIG. 3 illustrates a state in which the lens 31 faces a downward side, and B of FIG. 3 illustrates a state in which the lens 31 faces an upward side.

That is, the camera module provided with the lens 31 is mounted at the inside of the right unit 12 in a state in which angle can be adjusted by electric motion.

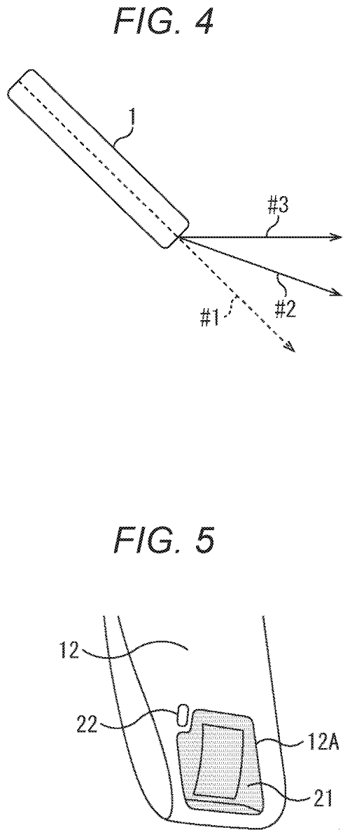

FIG. 4 is a view illustrating an image capture angle.

A broken-line arrow #1 is an arrow that passes through the center of a lateral surface (lateral surface of the band unit 11) of the information processing terminal 1. As indicated by the broken-line arrow #1, and solid-line arrows #2 and #3, it is possible to adjust the angle of the lens 31 to an arbitrary upward or downward angle.

In addition, in a case where the information processing terminal 1 does not perform image-capturing, as illustrated in FIG. 5, the lens 31 can be hidden by changing an angle of the camera module. A state illustrated in FIG. 5 is a state in which the lens 31 is not exposed from the opening 12A, and only a camera cover that rotates integrally with the camera module is confirmed from an outer side.

According to this arrangement, a human being who is close to the user who wears the information processing terminal 1 does not feel uneasy about being captured. In a case where the lens 31 is exposed, even though image-capturing is not performed, a human being close to the user who wears the information processing terminal 1 is worried about existence of the lens 31. It can be said that the configuration in which the lens 31 is hidden when image-capturing is not performed is a configuration that prevents uneasy feeling from being given to other peoples and considers privacy.

Furthermore, hereinafter, as illustrated in FIG. 5, changing of the angle of the camera module and hiding of the lens 31 are referred to as storage of the camera or closing of the camera cover. In addition, hereinafter, changing into a state in which the lens 31 is seen from an outer side by changing the angle of the camera module is referred to as opening of the camera cover.

Here, it is assumed that an image angle of an image is controlled by changing an angle of the camera module, that is, an angle of an optical axis of the lens 31. However, in a case where the lens 31 is a zoom lens, the image angle may be controlled by changing a focal length of the lens 31. Of course, the image angle may also be controlled by changing both the angle of the optical axis and the focal length. Optically, an image capture range of an image is defined by the angle of the optical axis and the focal length of the lens 31.

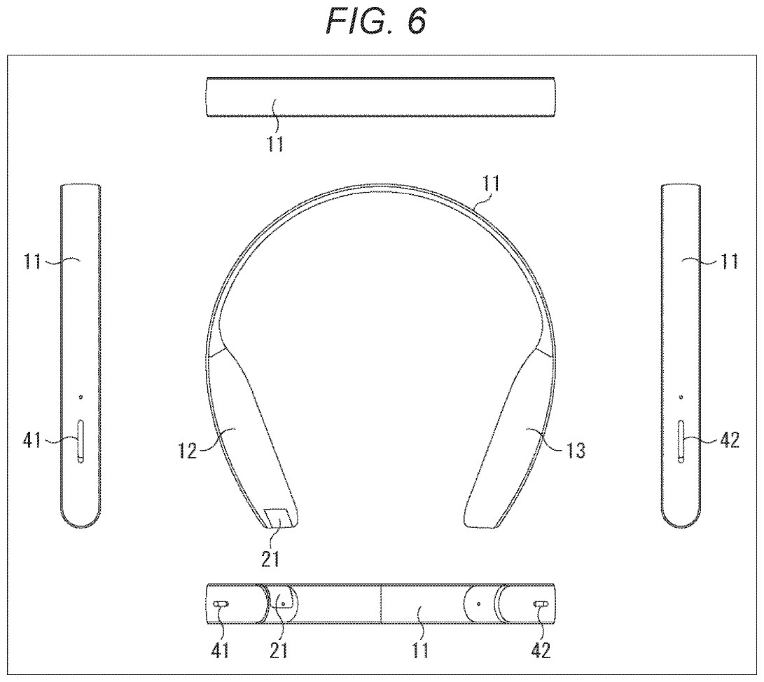

FIG. 6 to FIG. 8 are views illustrating the external appearance of the information processing terminal 1 in more detail.

The external appearance of the information processing terminal 1 in a front view is illustrated at the center of FIG. 6. As illustrated in FIG. 6, a speaker hole 41 is formed on a left surface of the information processing terminal 1, and a speaker hole 42 is formed on a right surface thereof.

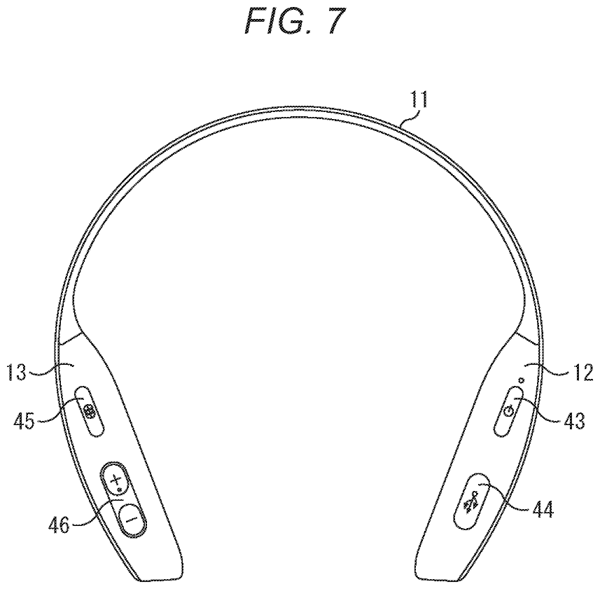

As illustrated in FIG. 7, a power button 43 and a USB terminal 44 are provided in a rear surface of the right unit 12. For example, the USB terminal 44 may be covered with a resin cover.

A custom button 45 that is operated when performing various kinds of setting, and a sound volume button 46 that is operated when adjusting a sound volume are provided in a rear surface of the left unit 13.

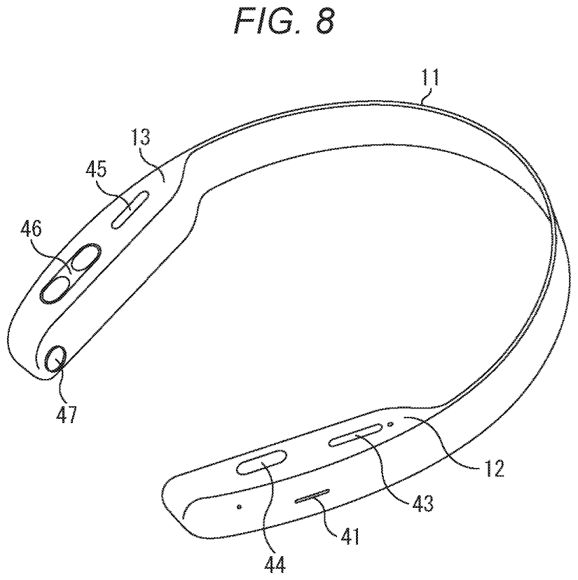

In addition, as illustrated in FIG. 8, an assist button 47 is provided in the vicinity of an inner tip end of the left unit 13. A predetermined function such as termination of capturing of a moving image can be allocated to the assist button 47.

### 2. Structure of Camera Block

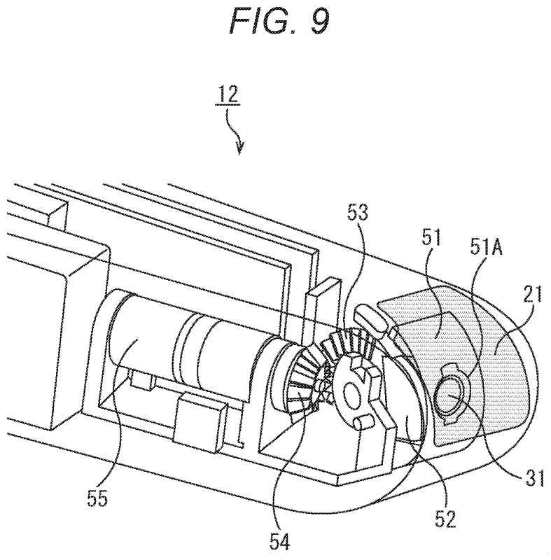

FIG. 9 is a view illustrating a structure of a camera block. The above-described camera module, the lens 31, and the like are included in the camera block.

A camera cover 51 obtained by curving a thin plate-shaped member is provided on an inner side of the cover 21 of the right unit 12. The camera cover 51 hides the inside from the opening 12A. An opening 51A is formed in the camera cover 51, and the lens 31 appears from the opening 51A. The camera cover 51 rotates in accordance with the adjustment of an angle of the camera module 52

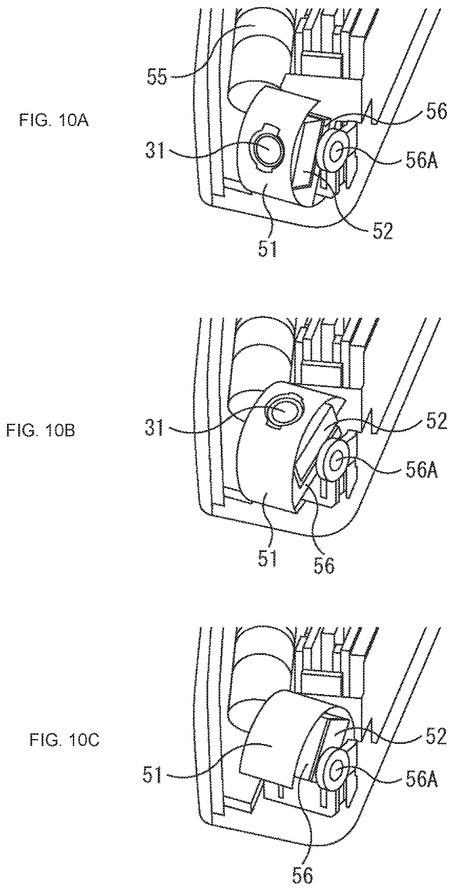

The camera module 52 has an approximately rectangular main body, and is constructed by mounting the lens 31 on an upper surface of the main body. The camera module 52 is fixed to a frame (FIG. 10, and the like) in which a rotating shaft is formed.

A bevel gear 53 and a bevel gear 54 are provided on a backward side of the camera module 52 in a state in which teeth are fitted to each other. The bevel gear 53 and the bevel gear 54 transmit the power of a motor 55 located on a backward side to the frame to which the camera module 52 is fixed.

The motor 55 is a stepping motor and rotates the bevel gear 54 in correspondence with a control signal. When using the stepping motor, it is possible to realize miniaturization of the camera block. The power generated by the motor 55 is transmitted to the frame, to which the camera module 52 is fixed, through the bevel gear 54 and the bevel gear 53. According to this power transmission, the camera module 52, and the lens 31 and the camera cover 51 which are integrated with the camera module 52 rotate around an axis of the frame.

FIG. 10 is a perspective view illustrating the structure of the camera block.

A camera frame 56, which rotates around a shaft 56A, is provided on a backward side of the camera module 52. The camera module 52 is mounted to the camera frame 56.

For example, an angle illustrated in A of FIG. 10 is the maximum rotation angle when a state in which the camera cover 51 is closed is set as a reference. In a case where the angle is set to turn upward from the state in A of FIG. 10, with regard to a direction of the camera module 52, it enters a state illustrated in B of FIG. 10.

In a case where the angle is set to further turn upward from the state in B of FIG. 10, and the camera cover 51 is closed, with regard to the direction of the camera module 52, it enters a state illustrated in C of FIG. 10. In the state in C of FIG. 10, from the opening 12A, only the camera cover 51 is seen through the cover 21, and the lens 31 is not seen. For example, an operation of the camera module 52 is initiated from the closed state in C of FIG. 10.

Angle adjustment of the camera module 52 is performed as described above. Even in a case where the camera module 52 is at any angle, a distance between an inner surface of the cover 21 and the lens 31 is always constant.

Furthermore, description has been given of an example in which the angle of the camera module 52 can be adjusted only in an upper and lower direction, but the angle may be adjusted in a right and left direction.

### 3. Inner Configuration of Information Processing Terminal

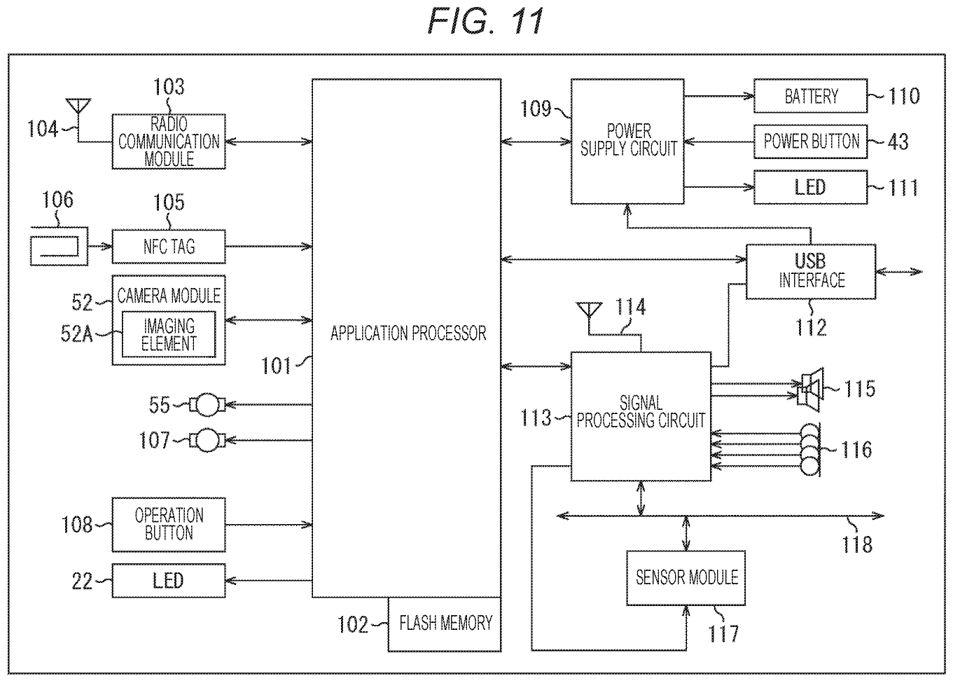

FIG. 11 is a block diagram illustrating an inner configuration example of the information processing terminal 1.

In FIG. 11, the same reference numeral will be given to the same configuration as described above. Redundant description will be appropriately omitted.

An application processor 101 reads out and executes a program stored in a flash memory 102, and the like, and controls the whole operation of the information processing terminal 1.

A radio communication module 103, an NFC tag 105, the camera module 52, the motor 55, a vibrator 107, an operation button 108, and the LED 22 are connected to the application processor 101. In addition, a power supply circuit 109, an USB interface 112, and a signal processing circuit 113 are connected to the application processor 101.

The radio communication module 103 is a module that performs radio communication of a predetermined standard such as Bluetooth (registered trademark) and Wi-Fi with an external device. For example, the radio communication module 103 performs communication with a portable terminal such as a smartphone carried by a user to transmit image data obtained through image-capturing or to receive music data. A BT/Wi-Fi antenna 104 is connected to the radio communication module 103. The radio communication module 103 may be configured to perform, for example, communication of mobile phone communication (3G, 4G, 5G, and the like) through a wide area network (WAN). In addition, it is not necessary for all of Bluetooth (registered trademark), Wi-Fi, WAN, and NFC to be mounted, and these may be selectively mounted. Modules which perform communication of Bluetooth (registered trademark), Wi-Fi, WAN, and NFC may be provided as individual modules, or may be provided as one module.

The near field communication (NFC) tag 105 performs near field communication in a case where a device including the NFC tag approaches the information processing terminal 1. An NFC antenna 106 is connected to the NFC tag 105.

The camera module 52 includes an imaging element 52A. A type of the imaging element 52A is not particularly limited, and examples thereof include a complementary metal oxide semiconductor (CMOS) image sensor, a charge coupled device (CCD) image sensor, and the like. The imaging element 52A performs image-capturing under control of the application processor 101, and supplies image data (hereinafter, also referred to simply as “image”) obtained as a result of image-capturing to the application processor 101.

The vibrator 107 vibrates in accordance with control by the application processor 101, and notifies a user of an incoming telephone call, reception of a mail, and the like. Information indicating the incoming telephone call, and the like are transmitted from a portable terminal carried by the user.

The operation button 108 includes various buttons provided in a casing of the information processing terminal 1, and examples thereof include the custom button 45, the sound volume button 46, and the assist button 47 which are illustrated in FIG. 7 and FIG. 8. A signal indicating the content of an operation with respect to the operation button 108 is supplied to the application processor 101.

A battery 110, a power button 43, an LED 111, and the USB interface 112 are connected to the power supply circuit 109. The power supply circuit 109 activates or stops the information processing terminal 1 in correspondence with an operation of the power button 43. In addition, the power supply circuit 109 supplies a current supplied from the battery 110 to respective units, or supplies a current supplied through the USB interface 112 to the battery 110 for charging.

The USB interface 112 performs communication with an external device through a USB cable that is connected to the USB terminal. In addition, the USB interface 112 supplies a current, which is supplied through the USB cable, to the power supply circuit 109.

The Signal processing circuit 113 performs processing of a signal transmitted from various sensors, and a signal supplied from the application processor 101. A speaker 115 and a microphone 116 are connected to the signal processing circuit 113. In addition, a sensor module 117 is connected to the signal processing circuit 113 through a bus 118.

For example, the signal processing circuit 113 performs positioning on the basis of a signal supplied from a global navigation satellite system (GNSS) antenna 114, and outputs position information to the application processor 101. That is, the signal processing circuit 113 functions as the GNSS sensor.

In addition, sensor data indicating a detection result by a plurality of sensors is supplied to the signal processing circuit 113 through the bus 118. The signal processing circuit 113 outputs sensor data indicating a detection result by each of the sensors to the application processor 101. In addition, the signal processing circuit 113 outputs music, a voice, a sound effect, and the like from the speaker 115 on the basis of data supplied from the application processor 101.

The microphone 116 detects a voice of a user, and outputs a detection result to the signal processing circuit 113. As described above, the operation of the information processing terminal 1 can also be performed by a voice.

The sensor module 117 includes various sensors configured to detect surrounding environment and a situation of the information processing terminal 1. A type of the sensors provided in the sensor module 117 is set in correspondence with a type of data that is necessary. For example, the sensor module 117 includes several sensors such as a gyro sensor, an acceleration sensor, a vibration sensor, an electronic compass, a pressure sensor, an acceleration sensor, an atmospheric pressure sensor, a proximity sensor, a pulse sensor, a perspiration sensor, a skin conduction microphone, and a terrestrial magnetism sensor. The sensor module 117 outputs a signal indicating a detection result of each of the sensors to the signal processing circuit 113 through the bus 118.

Furthermore, it is not necessary to constitute the sensor module 117 by one module, and the sensor module 117 may be divided into a plurality of modules.

In the example illustrated in FIG. 11, as the sensors which detect the surrounding environment and the situation of the information processing terminal 1, the camera module 52, the microphone 116, and the GNSS sensor (signal processing circuit 113) are provided in addition to the sensor module 117.

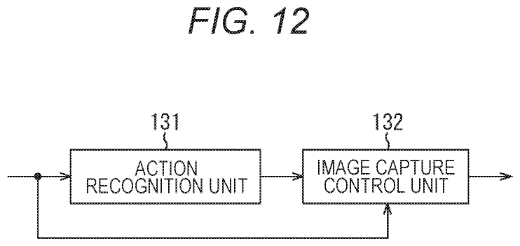

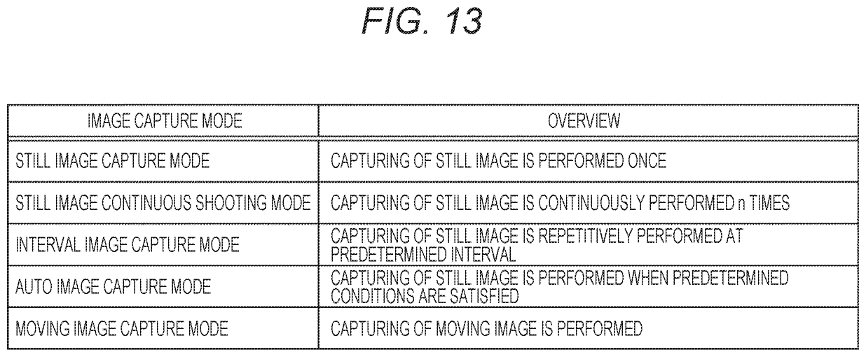

FIG. 12 is a block diagram illustrating a functional configuration example of the information processing terminal 1.

At least a part of functional units illustrated in FIG. 12 is realized when a predetermined program is executed by the application processor 101 illustrated in FIG. 11.

In the information processing terminal 1, an action recognition unit 131 and an image capture control unit 132 are realized.

The action recognition unit 131 performs recognition processing of a user's action on the basis of sensor data that is supplied from the signal processing circuit 113 and the like. For example, the action recognition unit 131 has information for action recognition which indicates a pattern of sensor data that is detected when a user takes an action. In addition, the action recognition unit 131 recognizes an action corresponding to a pattern of sensor data supplied from the signal processing circuit 113 and the like as a current user's action on the basis of the information for action recognition. The action recognition unit 131 outputs information indicating a recognition result of the user's action to the image capture control unit 132.

The image capture control unit 132 performs control of image-capturing by the camera module 52. For example, the image capture control unit 132 controls image capture parameters of the camera module 52 on the basis of the user's action recognized by the action recognition unit 131, sensor data that is supplied from the signal processing circuit 113, and the like. For example, the image capture control unit 132 has parameter control information in which the user's action and values of image capture parameters are correlated with each other. In addition, the image capture control unit 132 sets the image capture parameters of the camera module 52 to a value corresponding to the user's action with reference to the parameter control information.

Furthermore, the whole of image capture-related parameters of the camera module 52 can be a control target of the image capture control unit 132. However, among the parameters, a parameter related to an operation of the imaging element 52A and a parameter related to processing of a signal transmitted from the imaging element 52A are included. Examples of the parameter related to the operation of the imaging element 52A include a shutter speed of the imaging element 52A, an image capture timing that is defined by timing of an electronic shutter of the imaging element 52A, and the like. Examples of the parameter related to the processing of the signal transmitted from the imaging element 52A include sensitivity that is defined by a signal amplification gain, and a correction range of electronic type camera shake correction. The correction range of the camera shake correction is a range (hereinafter, referred to as “effective image capture image angle”) that is cut out from an image captured by the imaging element 52A so as to perform the camera shake correction.

In addition, the image capture control unit 132 performs setting of an image capture mode of the information processing terminal 1, a parameter of the image capture mode, and the like on the basis of a user operation, or sensor data that is supplied from the signal processing circuit 113 and the like. Here, an example of the image capture mode will be described with reference to FIG. 11.

For example, five types of image capture modes including a still image capture mode, a still image continuous shooting mode, an interval image capture mode, an auto image capture mode, and a moving image capture mode are prepared in the information processing terminal 1. For example, image-capturing is performed in a mode that is selected among the image capture modes by a user.

The still image capture mode is a mode in which capturing of a still image is performed once.

The still image continuous shooting mode is a mode in which capturing of a still image is continuously performed n times (n 2) to capture n sheets of still images. Furthermore, the number of times of image-capturing (the number of sheets of continuous shooting) can be arbitrarily set by a user. In addition, the number of times of image-capturing may be set in advance or may be set in image-capturing.

The interval image capture mode is a mode in which capturing of a still image is repetitively performed at a predetermined interval. Furthermore, a specific example of an image capture interval will be described later.

The auto image capture mode is a mode in which capturing of a still image is performed when a predetermined condition is satisfied. Furthermore, a specific example of an image capture condition will be described later.

The moving image capture mode is a mode in which capturing of a moving image is performed.

In addition, the image capture control unit 132 acquires an image obtained through image-capturing from the camera module 52, and outputs the acquired image to the flash memory 102 to be stored therein.

### 4. Processing of Information Processing Terminal

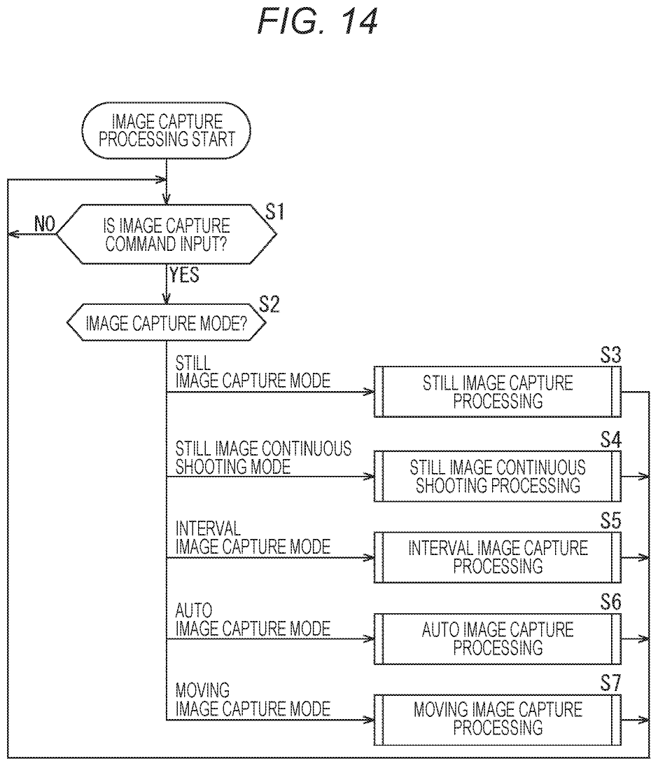

Next, description will be given of processing of the information processing terminal 1 with reference to FIG. 14 to FIG. 22.

First, description will be given of image capture processing executed by the information processing terminal 1 with reference to a flowchart of FIG. 14. For example, the processing is initiated when a user operates the power button 43 to activate the information processing terminal 1, and the processing is terminated when the information processing terminal 1 is stopped.

In step S1, the image capture control unit 132 determines whether or not an image capture command is input. For example, a user inputs an image capture command with a voice by speaking a voice of a predetermined content. At this time, for example, the image capture mode may be set by changing the content of the image capture command for every image capture mode. Alternatively, for example, the image capture mode may be set in advance, and an image capture command that gives an instruction for initiation of image-capturing may be input.

The determination processing in step S1 is repetitively executed until it is determined that the image capture command is input, and in a case where it is determined that the image capture command is input, the processing proceeds to step S2.

In step S2, the image capture control unit 132 makes a determination on the image capture mode. In a case where it is determined that the image capture mode is the still image capture mode, the processing proceeds to step S3.

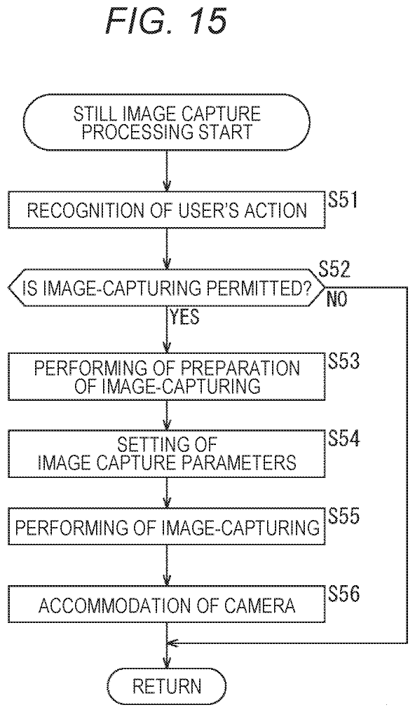

In step S3, the information processing terminal 1 executes still image capture processing. Here, details of the still image capture processing will be described with reference to a flowchart of FIG. 15.

In step S51, the action recognition unit 131 recognizes a user's action. For example, as described above, the action recognition unit 131 has information for action recognition which indicates a pattern of sensor data that is detected when the user takes an action. The action recognition unit 131 retrieves an action, which corresponds to the pattern of the sensor data supplied from the signal processing circuit 113 and the like, in the information for action recognition, and recognizes a detected action as a current user's action.

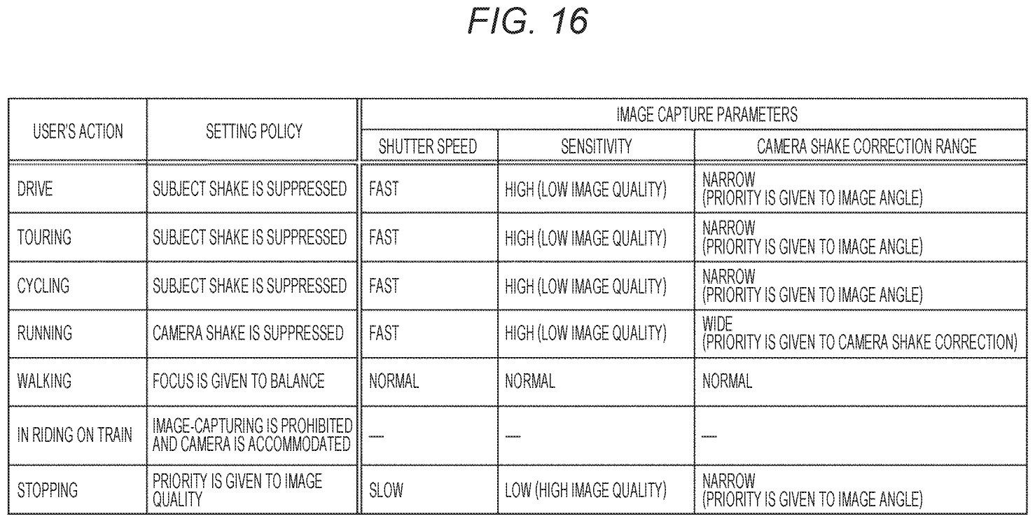

Furthermore, as illustrated in FIG. 16, description will be given of a case where user's actions are classified into seven types including drive (in riding in a car), touring (in riding on a motorbike), cycling (in riding on a bicycle), running (in running), walking (in walking), in riding on a train, and stopping (a body of the user hardly moves).

The seven types of actions are recognized, for example, on the basis of detection results of a current position of the user, a movement speed, vibration, and a posture. The current position of the user is detected, for example, by using a GNSS sensor. The movement speed is detected, for example, by using the GNSS sensor or a speed sensor. The vibration is detected, for example, by using an acceleration sensor. The posture is detected, for example, by using the acceleration sensor and a gyro sensor.

For example, in a case where the user is seated, the movement speed is high, the vibration is small, and the current position of the user is not in a station and on a railroad, the current user's action is recognized as “drive”.

For example, in a case where the user is in a forward-bent posture, the movement speed is high, the vibration is small, and the current position of the user is not in a station and on a railroad, the current user's action is recognized as “touring”.

For example, in a case where the user in a forward-bent posture, the movement speed is middle, and the vibration is intermediate, the current user's action is recognized as “cycling”.

For example, in a case where the user is in a standing posture, the movement speed is middle, and the vibration is large, the current user's action is recognized as “running”.

For example, in a case where the user is in a standing posture, the movement speed is low, and the vibration is large, the current user's action is recognized as “walking”.

For example, in a case where the movement speed of the user is high, the vibration is small, and the current position of the user is in a station or on a railroad, the current user's action is recognized as “riding on a train”.

For example, in a case where the movement speed of the user is approximately zero, and the vibration is small, the current user's action is recognized as “stopping”.

Furthermore, in a case where the user's action cannot be recognized, for example, the user's action cannot be specified to any one of the seven types, or in a case where the sensor data cannot be normally acquired, this case leads to a recognition error.

In step S52, the image capture control unit 132 makes a determination as to whether or not to permit image-capturing. For example, in a case where the recognition result of the user's action is “riding on a train”, the image capture control unit 132 prohibits image-capturing by considering privacy and the like of nearby passengers. In addition, for example, in a case where the recognition error occurs, the image capture control unit 132 prohibits image-capturing. On the other hand, in a case where the recognition error does not occur, and the recognition result of the user's action is other than “riding on a train”, the image capture control unit 132 permits image-capturing.

In addition, in a case where it is determined that image-capturing is permitted, the processing proceeds to step S53.

In step S53, the information processing terminal 1 performs preparation of image-capturing. For example, the image capture control unit 132 controls the signal processing circuit 113, and outputs a sound effect and a voice indicating that of image-capturing in the still image capture mode is performed from the speaker 115 in combination with a sound effect.

In addition, the image capture control unit 132 initiates light-emission of the LED 22. When the LED 22 emits light, it is possible to notify a user or a nearby person of execution of image-capturing.

In addition, the image capture control unit 132 controls the motor 55 to rotate the camera module 52 so as to set the camera cover 51 to “open”. According to this control, the lens 31 enters a state of being seen from the outside.

In step S54, the image capture control unit 132 sets image capture parameters.

An example of setting values of image capture parameters corresponding to respective user's actions is illustrated in FIG. 16. This example illustrates an example of setting values of three image capture parameters including a shutter speed, sensitivity, and a camera shake correction range. Among the three parameters, two parameters including the shutter speed and the sensitivity are set in capturing of a still image, and two parameters including the sensitivity and the camera shake correction range are set in capturing of a moving image.

For example, the shutter speed is set to three stages of “fast”, “normal”, “slow”. As the shutter speed becomes faster, an influence of subject shake and camera shake is further suppressed, and an image becomes darker. On the other hand, as the shutter speed becomes slower, an image becomes brighter, and the influence of the subject shake and the camera shake becomes greater.

For example, the sensitivity is set to three stages of “high”, “normal”, and “low”. As the sensitivity becomes higher, an image becomes brighter, but noise further increases, and image quality further deteriorates. On the other hand, as the sensitivity becomes lower, noise is further suppressed, and image quality is improved, but an image becomes darker.

For example, the camera shake correction range is set to three stages of “wide”, “normal”, and “narrow”. As the camera shake correction range becomes wider, priority is given to the camera shake correction, the influence of the camera shake is further suppressed, but an effective image capture image angle becomes narrower. On the other hand, as the camera shake correction range becomes narrower, priority is given to an image angle and the effective image capture image angle is further widened, and the influence of the camera shake becomes greater.

For example, in a case where the recognition result of the user's action is “drive”, “touring”, or “cycling”, that is, in a case where the movement speed of the user is an intermediate speed or higher, and the vibration is intermediate or less, setting in which priority is given to suppression of the subject shake is performed. Specifically, the shutter speed is set to “fast”, the sensitivity is set to “high”, and the camera shake correction range is set to “narrow”.

In a case where the recognition result of the user's action is “running”, that is, in a case where the movement speed of the user is intermediate, and the vibration is large, setting in which priority is given to suppression of the camera shake is performed. Specifically, the shutter speed is set to “fast”, the sensitivity is set to “high”, and the camera shake correction range is set to “wide”.

In a case where the recognition result of the user's action is “walking”, that is, in a case where the movement speed of the user is slow, and the vibration is large, setting is performed with focus given to balance between suppression of the subject shake and the camera shake, and image quality. Specifically, the shutter speed is set to “normal”, the sensitivity is set to “normal”, and the camera shake correction range is set to “normal”.

In a case where the recognition result of the user's action is “stopping”, that is, in a case where movement of the user and the vibration hardly occur, setting in which sufficient exposure time is taken and priority is given to image quality is performed. Specifically, the shutter speed is set to “slow”, the sensitivity is set to “low”, and the camera shake correction range is set to “narrow”.

In a case where the recognition result of the user's action is “riding on a train”, as described above, image-capturing is prohibited, and the camera is accommodated.

As described above, in the example illustrated in FIG. 16, substantially, the shutter speed, the sensitivity, and the camera shake correction range are set on the basis of the movement speed of the user and the vibration.

In addition, as illustrated in FIG. 16, the image capture control unit 132 has parameter control information in which the user's action and the values of the image capture parameters are correlated with each other. In addition, the image capture control unit 132 sets the image capture parameters of the camera module 52 in correspondence with a recognition result of the user's action on the basis of the parameter control information.

In step S55, the camera module 52 performs image-capturing under control of the image capture control unit 132. At this time, the image capture control unit 132 controls the signal processing circuit 113 to output a sound effect from the speaker 115 in conformity to image-capturing. In addition, the image capture control unit 132 terminates light-emission of the LED 22 in conformity to termination of image-capturing. In addition, the image capture control unit 132 acquires an image (still image) obtained through image-capturing from the camera module 52, and stores the image in the flash memory 102.

In step S56, the information processing terminal 1 accommodates the camera. That is, the image capture control unit 132 controls the motor 55 to rotate the camera module 52 so as to set the camera cover 51 to “close”. According to this control, the lens 31 enters a state of not seen from the outside.

Then, the still image capture processing is terminated.

On the other hand, in step S52, in a case where it is determined that image-capturing is prohibited, the processing in step S53 and S56 is skipped, and the still image capture processing is terminated without performing image-capturing.

As described above, in the still image capture mode, capturing of the still image is performed at a timing desired by a user with speech (an image capture command with a voice) of the user set as a trigger. In addition, since the image capture parameters are appropriately set in correspondence with a user's action in image-capturing, it is possible to obtain an image with high image quality, in which the camera shake or the subject shake are suppressed, at appropriate exposure regardless of movement of the user in image-capturing.

Returning to description in FIG. 14, after the still image capture processing is terminated, the processing returns to step S1, and the processing subsequent to step S1 is executed.

On the other hand, in step S2, in a case where it is determined that the image capture mode is the still image continuous shooting mode, the processing proceeds to step S4.

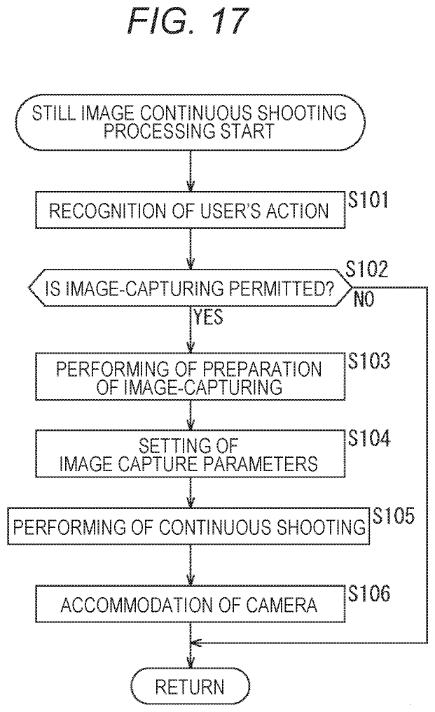

In step S4, the information processing terminal 1 executes still image continuous shooting processing. Here, details of the still image continuous shooting processing will be described with reference to a flowchart of FIG. 17.

In step S101, a user's action is recognized in a similar manner to the processing in step S51 in FIG. 15.

In step S102, determination is made as to whether or not to permit image-capturing in a similar manner to the processing in step S52 in FIG. 15. In a case where it is determined that image-capturing is permitted, the processing proceeds to step S103.

In step S103, preparation of image-capturing is performed in a similar manner to the processing in step S53 in FIG. 15. However, differently from the processing in step S53, a voice indicating that image-capturing in the still image continuously shooting mode is performed is output from the speaker 115 in combination with a sound effect.

In step S104, image capture parameters are set in a similar manner to the processing in step S54 in FIG. 15. Furthermore, in the still image continuous shooting mode, among the image capture parameters in FIG. 16, the shutter speed and the sensitivity are set.

In step S105, the information processing terminal 1 performs continuous shooting. Specifically, the camera module 52 continuously performs still image-capturing by the number of times, which is set, under control of the image capture control unit 132. At this time, the image capture control unit 132 controls the signal processing circuit 113 to output a sound effect from the speaker 115 in conformity to image-capturing. In addition, the image capture control unit 132 terminates light-emission of the LED 22 in conformity to termination of image-capturing. In addition, the image capture control unit 132 acquires an image (still image) obtained through image-capturing from the camera module 52, and stores the image in the flash memory 102.

Furthermore, the setting of the number of times of image-capturing may be performed, for example, by an image capture command, or may be performed in advance.

In step S106, the camera is accommodated in a similar manner to the processing in step S56 in FIG. 15.

Then, the still image continuous shooting processing is terminated.

On the other hand, in step S102, in a case where it is determined that image-capturing is prohibited, the processing in steps S103 to S106 is skipped, and the still image continuous shooting processing is terminated without performing image-capturing.

As described above, in the still image continuous shooting mode, still image-capturing is continuously performed by a desired number of times at timing desired by the user with a speech (an image capture command with a voice) of the user set as a trigger. In addition, since the image capture parameters are appropriately set in correspondence with a user's action in image-capturing, it is possible to obtain an image with high image quality, in which the camera shake or the subject shake are suppressed, at appropriate exposure regardless of movement of the user in image-capturing.

Returning to description in FIG. 14, after the still image continuous shooting processing is terminated, the processing returns to step S1, and the processing subsequent to step S1 is executed.

On the other hand, in step S2, in a case where it is determined that the image capture mode is the interval image capture mode, the processing proceeds to step S5.

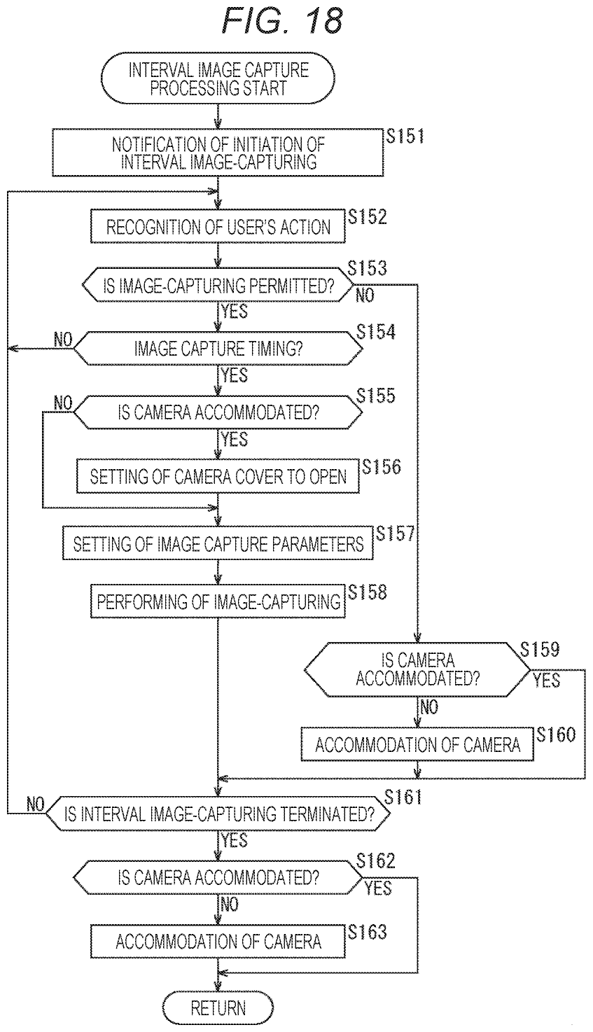

In step S5, the information processing terminal 1 executes interval image capture processing. Here, details of the interval image capture processing will be described with reference to a flowchart of FIG. 18.

In step S151, the information processing terminal 1 gives a notification of initiation of the interval image-capturing. For example, the image capture control unit 132 controls the signal processing circuit 113 to output a voice indicating initiation of image-capturing in the interval image capture mode from the speaker 115 in combination with a sound effect.

In step S152, a user's action is recognized in a similar manner to the processing in step S51 in FIG. 15.

In step S153, determination is made as to whether or not to permit image-capturing in a similar manner to the processing in step S52 in FIG. 15. In a case where it is determined that image-capturing is permitted, the processing proceeds to step S154.

In step S154, the image capture control unit 132 determines whether or not it is an image capture timing.

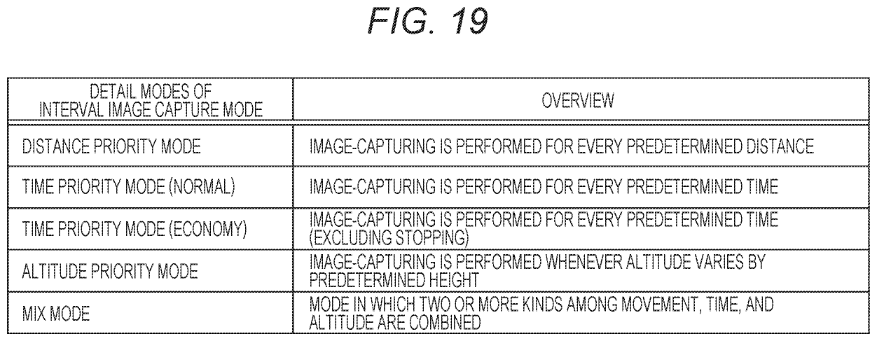

For example, as illustrated in FIG. 19, the interval image capture mode is also divided into five types of detail modes including a distance priority mode, a time priority mode (normal), a time priority mode (economy), an altitude priority mode, and a mix mode.

The distance priority mode is a mode in which image-capturing is performed whenever a user moves by a predetermined distance.

The time priority mode (normal) is a mode in which image-capturing is performed whenever a predetermined time has elapsed.

The time priority mode (economy) is a mode in which image-capturing is performed whenever a predetermined time has elapsed as in the time priority mode (normal). However, a time for a period in which the recognition result of the user's action is “stopping” is not counted. According to this configuration, for example, the number of times of image-capturing is suppressed, and the same image is prevented from being repetitively captured by several sheets when the user stops.

The altitude priority mode is a mode in which image-capturing is performed whenever an altitude of a location of a user varies by a predetermined height.

The mix mode is a mode in which two or more among a distance, time, and an altitude are combined. For example, in a case of a combination of a distance and time, image-capturing is performed whenever a user moves by a predetermined distance, or whenever a predetermined time has elapsed.

Setting of the respective detail modes may be performed, for example, by an image capture command, or may be performed in advance. In addition, in the middle of the interval image-capturing, setting of the detail modes may be appropriately changed.

Alternatively, the detail modes may be automatically switched from each other, for example, in correspondence with conditions (a surrounding environment, a situation of a user, and the like) based on sensor data. For example, in a case where a movement speed of the user is equal to or greater than a predetermined threshold value, setting may be made to the distance priority mode, and in a case where the movement speed of the user is less than the predetermined threshold value, setting may be made to the time priority mode.

In addition, setting of a combination of a distance, time, and an altitude in the mix mode may be performed by an image capture command, or may be performed in advance. Alternatively, combinations of the mix mode may be automatically switched from each other, for example, in correspondence with conditions based on the sensor data.

In addition, parameters (a distance, time, or a height) which define an image capture interval of the respective detail modes may be set to a fixed value, or a variable value. In a case where the parameters are variable, for example, the parameters may be set by an image capture command or may be set in advance. Alternatively, the parameters may be automatically adjusted, for example, in correspondence with conditions based on the sensor data.

In a case of performing first image-capturing, in the processing in step S154 in the first image-capturing, the image capture control unit 132 makes a determination as “image capture timing” regardless of setting of the detail modes. According to this configuration, first image-capturing is performed immediately after initiation of the interval image capture processing except for a case where image-capturing is prohibited.

On the other hand, in a case of performing second or later image-capturing, the image capture control unit 132 determines whether or not it is an image capture timing on the basis of whether or not an image capture interval that is set is satisfied with a position, time, or an altitude at previous image-capturing set as a reference.

In addition, in a case where it is determined that timing is not the image capture timing, the processing returns to step S152.

Then, the processing in steps S152 to S154 is repetitively executed until it is determined in step S153 that image-capturing is prohibited, or it is determined in step S154 that timing is not the image capture timing.

On the other hand, in step S154, in a case where it is determined that timing is the image capture timing, the processing proceeds to step S155.

In step S155, the image capture control unit 132 determines whether or not a camera is accommodated. In a case where it is determined the camera is accommodated, the processing proceeds to step S156.

In step S156, the image capture control unit 132 controls the motor 55 to rotate the camera module 52 so as to set the camera cover 51 to “open”. According to this configuration, the lens 31 enters a state of being seen from the outside.

Then, the processing proceeds to step S157.

On the other hand, in step S155, in a case where it is determined that the camera is not accommodated, the processing in step S156 is skipped, and the processing proceeds to step S157.

In step S157, image capture parameters are set in a similar manner to the processing in step S54 in FIG. 15. Furthermore, in the interval image capture mode, among the image capture parameters in FIG. 16, the shutter speed and the sensitivity are set. At this time, the image capture control unit 132 initiates light-emission of the LED 22. When the LED 22 emits light, it is possible to notify a user or a nearby person of execution of image-capturing.

In step S158, image-capturing is performed in a similar manner to the processing in step S55 in FIG. 15.

At this time, it is also possible to perform continuous shooting in a similar manner to the processing in step S105 in FIG. 17. Furthermore, whether to perform image-capturing once or to perform continuous shooting may be set by a user, or may be automatically switched from each other in correspondence with conditions based on the sensor data.

Then, the processing proceeds to step S161.

On the other hand, in step S153, in a case where it is determined that image-capturing is prohibited, the processing proceeds to step S159.

In step S159, it is determined whether or not the camera is accommodated in a similar manner to the processing in step S155. In a case where it is determined that the camera is not accommodated, the processing proceeds to step S160.

In step S160, the camera is accommodated in a similar manner to the processing in step S56 in FIG. 15. According to this configuration, during a period in which a user rides on a train, the interval image-capturing is interrupted by considering privacy and the like of nearby passengers, and the lens 31 is hidden to prevent uneasy feeling from being given to the nearby passenger. In addition, in a case where a user's action cannot be recognized, the interval image-capturing is also interrupted.

Then, the processing proceeds to step S161.

On the other hand, in step S159, in a case where it is determined that the camera is accommodated, the processing in step S160 is skipped, and the processing proceeds to step S161. For example, this situation corresponds to a case where the interval image-capturing is not executed yet or a case where the interval image-capturing is already interrupted.

In step S161, the image capture control unit 132 determines whether or not to terminate the interval image-capturing. In a case where termination conditions of the interval image-capturing are not satisfied, the image capture control unit 132 determines that the interval image-capturing is not terminated, and the processing returns to step S152.

Then, the processing in steps S152 to S161 is repetitively executed until it is determined in step S161 that the interval image-capturing is terminated. According to this configuration, capturing of a still image is repetitively performed at a predetermined interval except for a period in which the interval image-capturing is interrupted.

On the other hand, in a case where the termination conditions of the interval image-capturing are satisfied, in step S161, the image capture control unit 132 determines that the interval image-capturing is terminated, and the processing proceeds to step S162.

Here, as the termination conditions of the interval image-capturing, for example, the following conditions are considered.
Case where a duration of an interval image capture period is greater than a threshold value
Case where the number of times of image-capturing during the interval image capture period is greater than a threshold value
Case where a residual amount of the flash memory 102 becomes less than a predetermined threshold value
Case where a stopping command is input

Furthermore, the above-described threshold value may be set to a fixed value, or a variable value. In a case where the threshold value is variable, for example, the threshold value may be set by a user, or may be automatically set in accordance with conditions based on the sensor data.

In addition, for example, the stopping command may be input with a voice in a similar manner to the image capture command.

In step S162, it is determined whether or not the camera is accommodated in a similar manner to the processing in step S155. In a case where it is determined that the camera is not accommodated, the processing proceeds to step S163.

In step S163, the camera is accommodated in a similar manner to the processing in step S56 in FIG. 15.

Then, the interval image capture processing is terminated.

On the other hand, in step S162, in a case where it is determined that the camera is accommodated, the processing in step S163 is skipped, and the interval image capture processing is terminated.

As described above, in the interval image capture mode, image-capturing is repetitively performed at an appropriate interval with speech (an image capture command with a voice) by a user set as a trigger. In addition, since the image capture parameters are appropriately set in correspondence with a user's action in image-capturing, it is possible to obtain an image with high image quality, in which the camera shake or the subject shake are suppressed, at appropriate exposure regardless of movement of the user in image-capturing.

Returning to description of FIG. 14, after the interval image capture processing is terminated, the processing returns to step S1, and the processing subsequent to step S1 is executed.

On the other hand, in step S2, in a case where it is determined that the image capture mode is the auto image capture mode, the processing proceeds to step S6.

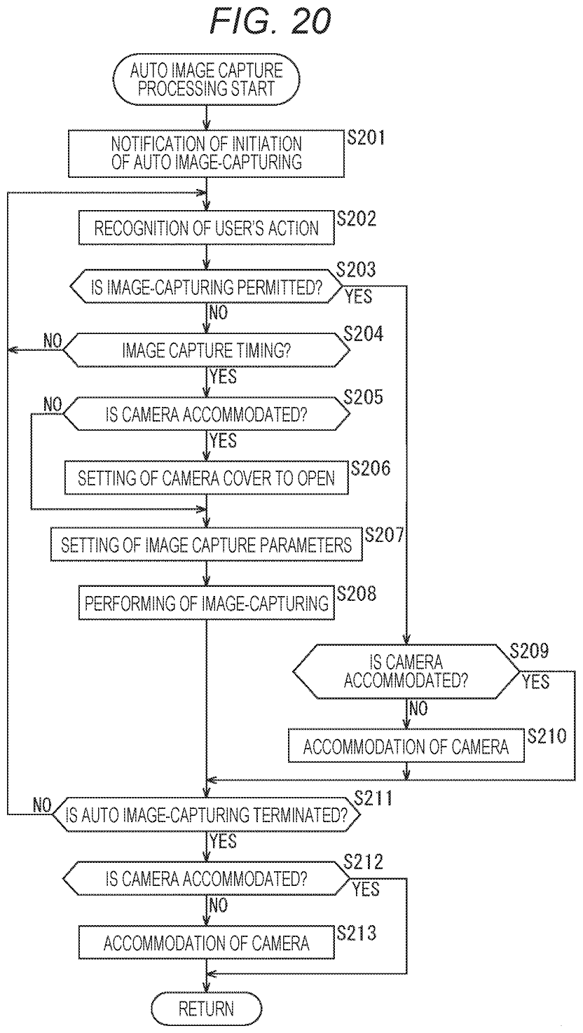

In step S6, the information processing terminal 1 executes the auto image capture processing. Here, details of the auto image capture processing will be described with reference to a flowchart of FIG. 20.

In step S201, the information processing terminal 1 gives a notification of initiation of the auto image-capturing. For example, the image capture control unit 132 controls the signal processing circuit 113 to output a voice indicating initiation of image-capturing in the auto image capture mode from the speaker 115 in combination with a sound effect.

In step S202, a user's action is recognized in a similar manner to the processing in step S51 in FIG. 15.

In step S203, determination is made as to whether or not to permit image-capturing in a similar manner to the processing in step S52 in FIG. 15. In a case where it is determined that image-capturing is permitted, the processing proceeds to step S204.

In step S204, the image capture control unit 132 determines whether or not it is an image capture timing.

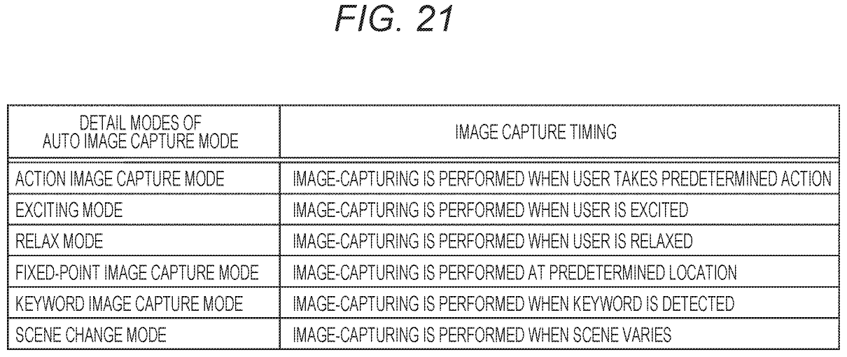

For example, as illustrated in FIG. 21, the auto image capture mode is divided into six types of detail modes including an action image capture mode, an exciting mode, a relax mode, a fixed-point image capture mode, a keyword image capture mode, and a scene change mode.

The action image capture mode is a mode in which image-capturing is performed when a user takes a predetermined action. Furthermore, an image capture timing may be arbitrarily set. For example, image-capturing may be periodically performed during a period in which the user takes a predetermined action, or image-capturing may be performed at a predetermined timing such as indication or termination of an action.

Furthermore, for example, an action that becomes an image capture target, or an image capture timing may be set by an image capture command or may be set in advance.

The exciting mode and the relax mode are modes in which the image capture timing is controlled on the basis of biological information of the user. Specifically, the exciting mode is a mode in which image-capturing is performed in a case where it is determined that the user is excited. The relax mode is a mode in which image-capturing is performed in a case where it is determined that the user is relax. For example, it is determined whether or not the user is excited or relaxed, for example, on the basis of a user's pulse detected by the pulse sensor, the amount of a user's perspiration detected by the perspiration sensor, and the like.

Furthermore, the image capture timing may be arbitrarily set. For example, image-capturing may be periodically performed during a period in which the user is determined as “excited” or “relaxed”, or image-capturing may be performed immediately after determination as “excited” or “relaxed”. Furthermore, for example, the image capture timing may be set by an image capture command or may be set in advance.

The fixed-point image capture mode is a mode in which image-capturing is performed at a predetermined location. For example, image-capturing is performed when a user's current position detected by using the GNSS sensor, the terrestrial magnetism sensor, and the like is a predetermined location. The fixed-point image capture mode can be used, for example, in a case of desiring to periodically observe a time-series variation (for example, progression status of construction, growth of plants, and the like) of a predetermined location.

Furthermore, for example, the location that becomes an image capture target may be set by an image capture command or may be set in advance.

The keyword image capture mode is a mode in which image-capturing is performed when a predetermined keyword of voice is detected by the microphone 116. For example, in a case where a keyword such as “looks at” of encouraging a user to pay attention is detected in the voice, image-capturing is performed. According to this configuration, it is possible to perform image-capturing without missing an impressive scene, an important scene, and the like.

In addition, for example, when “setting sun” that is a keyword in a voice of “the setting sun is beautiful” is detected, image-capturing is performed. According to this configuration, it is possible to perform image-capturing without missing a predetermined target.

Furthermore, for example, the keyword may be set by an image capture command, or may be set in advance.

The scene change mode is a mode in which image-capturing is performed when a scene varies. Hereinafter, an example of a method of detecting a scene variation will be described.

For example, a variation of a scene is detected on the basis of a variation amount of feature data of an image that is captured by the camera module 52.

In addition, a variation of a scene is detected on the basis of a user's current position detected by using the GNSS sensor. For example, a variation of a scene is detected in a case where the user moves to another building or a room, a case where the user moves from an outdoor side to an indoor side or from an indoor side to an outdoor side, and the like.

In addition, a variation of a scene is detected on the basis of a variation of a temperature detected by the temperature sensor. For example, a variation of a scene is detected in a case where a user moves from an outdoor side to an indoor side or from an indoor side to an outer side, and the like.

In addition, a variation of a scene is detected on the basis of a variation of an atmospheric pressure detected by using the atmospheric pressure sensor. For example, a variation of a scene is detected in a case where weather rapidly varies, and the like.

In addition, a variation of a scene is detected on the basis of a variation of a sound detected by using the microphone 116. For example, a variation of a scene is detected in a case where an event that makes a sound occurs in surrounding, in a case where a human being or an object that makes a sound approaches, in a case where a user or a nearby human being speaks, in a case where the user moves to a location from which a sound is made, and the like.

In addition, a variation of a scene is detected on the basis of impact, which is detected by using the acceleration sensor, to the information processing terminal 1. For example, a variation of a scene is detected in a case where an event (for example, an accidence, overturning, and the like) that gives impact to the user occurs, and the like.

In addition, a variation of a scene is detected on the basis of a direction, which is detected by using a gyro sensor, of the information processing terminal 1. For example, a variation of a scene is detected in a case where a user changes a direction of a body or a direction of a part of (for example, a head, a face, and the like) of a body, in a case where the user changes a posture, and the like.

In addition, a variation of a scene is detected on the basis of surrounding brightness detected by using an illuminance sensor. A variation of a scene is detected in a case where a user moves from a dark location to a bright location or from a dark location to a bright location, in a case where illumination is turned on or turned off, and the like.

For example, setting of the respective detail modes may be performed by an image capture command, or may be performed in advance. In addition, setting of the detail modes may be appropriately changed in the middle of the auto image-capturing. Alternatively, for example, the detail modes may be automatically switched from each other in correspondence with conditions based on the sensor data.

Furthermore, two or more types of the detail modes may be simultaneously set.

In addition, in a case where conditions defined by the detail modes of the auto image capture mode are not satisfied, the image capture control unit 132 determines that timing is not an image capture timing, and the processing returns to step S202.

Then, in step S203, the processing of steps S202 to S204 is repetitively executed until it is determined in step S203 that image-capturing is prohibited, or it is determined in step S204 that timing is an image capture timing.

On the other hand, in step S204, in a case where it is determined that timing is an image capture timing, the processing proceeds to step S205.

In step S205, it is determined whether or not the camera is accommodated in a similar manner to the processing in step S155 in FIG. 18. In a case where it is determined that the camera is accommodated, the processing proceeds to step S206.

In step S206, the camera cover 51 is set to “open” in a similar manner to the processing in step S156 in FIG. 18.

Then, the processing proceeds to step S207.

On the other hand, in step S205, in a case where it is determined that the camera is not accommodated, the processing in step S206 is skipped, and the processing proceeds to step S207.

In step S207, image capture parameters are set in a similar manner to the processing in step S54 in FIG. 15. Furthermore, in the auto image capture mode, among the image capture parameters in FIG. 16, the shutter speed and the sensitivity are set. At this time, the image capture control unit 132 initiates light-emission of the LED 22. When the LED 22 emits light, it is possible to notify a user or a nearby person of execution of image-capturing.

In step S208, image-capturing is performed in a similar manner to the processing in step S55 in FIG. 15.

At this time, it is also possible to perform continuous shooting in a similar manner to the processing in step S105 in FIG. 17. Furthermore, whether to perform image-capturing once or to perform continuous shooting may be set by a user, or may be automatically switched from each other in correspondence with conditions based on the sensor data.

In addition, images before and after the image capture timing may be acquired and stored. For example, the camera module 52 always performs image-capturing during execution of the auto image-capturing, and the image capture control unit 132 temporarily stores still images before a predetermined time to a current time in a buffer (not illustrated). In addition, in a case where it is determined that timing is the image capture timing, the image capture control unit 132 stores still images captured in a predetermined period before and after the image capture timing in the flash memory 102. Furthermore, in this case, image-capturing is always performed, but a period in which images for a predetermined period before and after the image capture timing are stored may be regarded as a formal image capture period, that is, a period in which image-capturing is substantially performed. That is, in this example, a substantial image capture timing is controlled.

Then, the processing proceeds to step S211.

On the other hand, in step S203, in a case where it is determined that image-capturing is prohibited, the processing proceeds to step S209.

In step S209, it is determined whether or not the camera is accommodated in a similar manner to the processing in step S155 in FIG. 18. In a case where it is determined that the camera is not accommodated, the processing proceeds to step S210.

In step S210, the camera is accommodated in a similar manner to the processing in step S56 in FIG. 15. According to this configuration, during a period in which a user rides on a train, the auto image-capturing is interrupted by considering privacy and the like of nearby passengers, and the lens 31 is hidden to prevent uneasy feeling from being given to the nearby passenger. In addition, in a case where a user's action cannot be recognized, the auto image-capturing is also interrupted.

Then, the processing proceeds to step S211.

On the other hand, in step S209, in a case where it is determined that the camera is accommodated, the processing in step S210 is skipped, and the processing proceeds to step S211. For example, this situation corresponds to a case where the auto image-capturing is not executed yet or a case where the auto image-capturing is already interrupted.

In step S211, the image capture control unit 132 determines whether or not to terminate the auto image-capturing. In a case where termination conditions of the auto image-capturing are not satisfied, the image capture control unit 132 determines that the auto image-capturing is not terminated, and the processing returns to step S202.

Then, the processing in steps S202 to S211 is repetitively executed until it is determined in step S211 that the auto image-capturing is terminated. According to this configuration, capturing of a still image is performed whenever predetermined conditions are satisfied except for a period in which the auto image-capturing is interrupted.

On the other hand, in a case where the termination conditions of the auto image-capturing are satisfied, in step S211, the image capture control unit 132 determines that the auto image-capturing is terminated, and the processing proceeds to step S212.

Here, as the termination conditions of the auto image-capturing, for example, the following conditions are considered.
Case where a duration of an auto image capture period is greater than a threshold value
Case where the number of times of image-capturing during the auto image capture period is greater than a threshold value
Case where a residual amount of the flash memory 102 becomes less than a predetermined threshold value
Case where a stopping command is input

Furthermore, the above-described threshold value may be set to a fixed value, or a variable value. In a case where the threshold value is variable, for example, the threshold value may be set by a user, or may be automatically set in accordance with conditions based on the sensor data.

In step S212, it is determined whether or not the camera is accommodated in a similar manner to the processing in step S155 in FIG. 18. In a case where it is determined that the camera is not accommodated, the processing proceeds to step S213.

In step S213, the camera is accommodated in a similar manner to the processing in step S56 in FIG. 15.

Then, the auto image capture processing is terminated.

On the other hand, in step S212, in a case where it is determined that the camera is accommodated, the processing in step S213 is skipped, and the auto image capture processing is terminated.

As described above, in the auto image capture mode, image-capturing is performed whenever desired conditions are satisfied with speech (an image capture command with a voice) by a user set as a trigger. In addition, since the image capture parameters are appropriately set in correspondence with a user's action in image-capturing, it is possible to obtain an image with high image quality, in which the camera shake or the subject shake are suppressed, at appropriate exposure regardless of movement of the user in image-capturing.

Returning to description of FIG. 14, after the auto image capture processing is terminated, the processing returns to step S1, and the processing subsequent to step S1 is executed.

On the other hand, in step S2, in a case where it is determined that the image capture mode is the moving image capture mode, the processing proceeds to step S7.

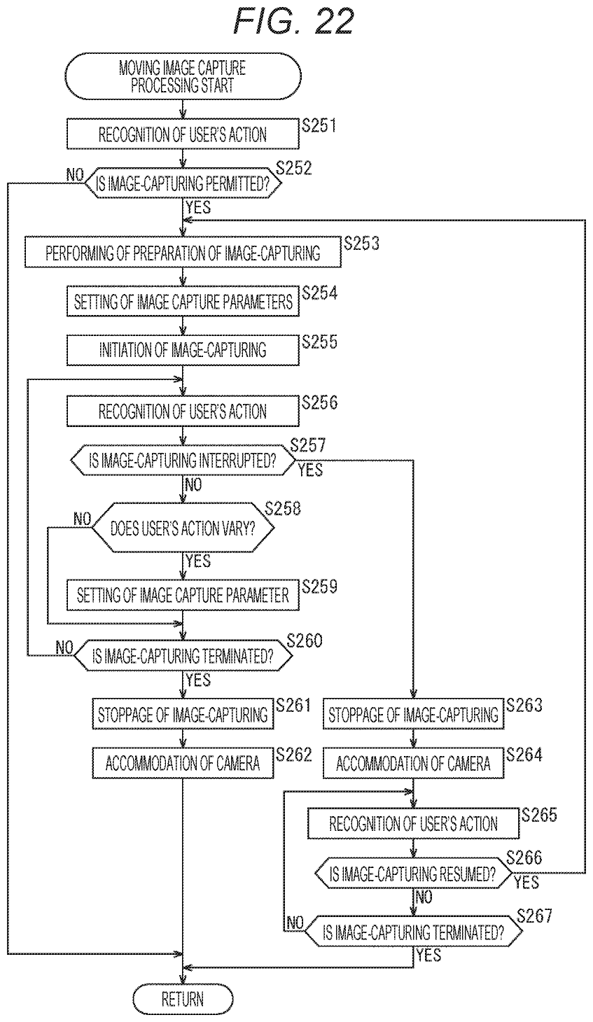

In step S7, the information processing terminal 1 executes the moving image capture processing. Here, details of the moving image capture processing will be described with reference to a flowchart of FIG. 22.

In step S252, a user's action is recognized in a similar manner to the processing in step S51 in FIG. 15.

In step S253, determination is made as to whether or not to permit image-capturing in a similar manner to the processing in step S52 in FIG. 15. In a case where it is determined that image-capturing is permitted, the processing proceeds to step S253.

In step S253, preparation of image-capturing is performed in a similar manner to the processing in step S53 in FIG. 15. However, differently from the processing in step S53, a voice indicating that image-capturing in the moving image capture mode is performed is output from the speaker 115 in combination with a sound effect.

In step S254, image capture parameters are set in a similar manner to the processing in step S54 in FIG. 15. Furthermore, in the moving image capture mode, among the image capture parameters in FIG. 16, the sensitivity and the camera shake correction range are set.

In step S255, the information processing terminal 1 initiates image-capturing. Specifically, the camera module 52 initiates capturing of a moving image under control of the image capture control unit 132. The image capture control unit 132 acquires moving images obtained through the image-capturing from the camera module 52, and sequentially stores the moving image in the flash memory 102.

In step S256, a user's action is recognized in a similar manner to the processing in step S2 in FIG. 14.

In step S257, the image capture control unit 132 determines whether or not to interrupt image-capturing. For example, in a case where the recognition result of the user's action is “riding on a train”, the image capture control unit 132 interrupts image-capturing by considering privacy and the like of nearby passengers. In addition, in a case where a recognition error occurs, for example, the image capture control unit 132 interrupts image-capturing. On the other hand, in a case where the recognition error does not occur, and the recognition result of the user's action is other than “in riding on a train”, the image capture control unit 132 continues image-capturing. In addition, in a case where it is determined that image-capturing is continued, the processing proceeds to step S258.

In step S258, the image capture control unit 132 determines whether or not the user's action varies on the basis of the recognition result of the user's action by the action recognition unit 131. In a case where it is determined that the user's action varies, the processing proceeds to step S259.

In step S259, image capture parameters are set in a similar manner to the processing in step S254. According to this configuration, setting of the image capture parameters is changed in correspondence with a variation of the user's action.

Then, the processing proceeds to step S260.

On the other hand, in step S258, in a case where it is determined that the user' action does not vary, the processing in step S259 is skipped, and the processing proceeds to step S260.

In step S260, the image capture control unit 132 determines whether or not to terminate image-capturing. In a case where image capture termination conditions are not satisfied, the image capture control unit 132 determines that image-capturing is not terminated, and the processing returns to step S256.

Then, the processing in steps S256 to S260 is repetitively executed until it is determined in step S257 that image-capturing is interrupted, or it is determined in step S260 that image-capturing is terminated.

On the other hand, in a case where the image capture termination conditions are satisfied, in step S260, the image capture control unit 132 determines that image-capturing is terminated, and the processing proceeds to step S261.

Here, as the image capture termination conditions, for example, the following conditions are considered.
Case where an image capture time of the moving image is greater than a threshold value
Case where a residual amount of the flash memory 102 becomes less than a predetermined threshold value
Case where a stopping command is input

Furthermore, the above-described threshold value may be set to a fixed value, or a variable value. In a case where the threshold value is variable, for example, the threshold value may be set by a user, or may be automatically set in accordance with conditions based on the sensor data.

In step S261, the camera module 52 stops image-capturing under control of the image capture control unit 132.

In step S262, the camera is accommodated in a similar manner to the processing in step S56 in FIG. 15.

Then, the moving image capture processing is terminated.

On the other hand, in step S257, in a case where it is determined that image-capturing is interrupted, the processing proceeds to step S263.

In step S263, image-capturing is stopped in a similar manner to the processing in step S261.

In step S264, the camera is accommodated in a similar manner to the processing in step S56 in FIG. 15.

In step S265, a user's action is recognized in a similar manner to the processing in step S51 in FIG. 15.

In step S266, the image capture control unit 132 determines whether or not to resume image-capturing. For example, in a case where the recognition result of the user's action is “in riding on a train” or in a case where a recognition error occurs, the image capture control unit 132 determines that image-capturing is not resumed, and the processing proceeds to step S267.

In step S267, it is determined whether or not to terminate image-capturing in a similar manner to the processing in step S260. In a case where it is determined that image-capturing is not terminated, the processing returns to step S265.

Then, the processing in steps S265 to S267 is repetitively executed until it is determined in step S266 that image-capturing is resumed, or it is determined in step S267 that image-capturing is terminated.

On the other hand, in step S266, in a case where it is determined that image-capturing is resumed, the processing returns to step S253.

Then, the processing subsequent to step S253 is executed, and capturing of a moving image is resumed.

In addition, in step S267, it is determined that image-capturing is terminated, the moving image capture processing is terminated.

On the other hand, in step S252, in a case where it is determined that image-capturing is prohibited, the processing in steps S253 to S267 is skipped, and the moving image capture processing is terminated without performing image-capturing.

As described above, in the moving image capture mode, image-capturing of the moving image is initiated with speech (an image capture command with a voice) of the user set as a trigger. In addition, image-capturing of the moving image is terminated with speech (a termination command with a voice) of the user set as a trigger. In addition, since the image capture parameters are appropriately set in correspondence with a user's action in image-capturing, it is possible to obtain an image with high image quality, in which the camera shake or the subject shake are suppressed, at appropriate exposure regardless of movement of the user in image-capturing.

Returning to description in FIG. 14, after the moving image capture processing is terminated, the processing returns to step S1, and the processing subsequent to step S1 is executed.

As described above, in the respective image capture modes, since the image capture parameters (including an image capture timing) is controlled on the basis of a recognition result of the user's action, it is possible to easily obtain an appropriate image corresponding to the user's action. As a result, the degree of satisfaction of the user is improved.

In addition, the user can operate the information processing terminal 1 with a voice without touching the information processing terminal 1. That is, in a case where it is necessary to operate a button in image-capturing, a user's action may be interrupted in accordance with the content of the operation. However, it is not necessary to interrupt the action, and comfortable and natural image-capturing is possible as soon as he/she thinks of it. In addition, it is possible to suppress the number of buttons, and it is advantages in securement of strength of a casing of the information processing terminal 1, or securement water repellence thereof.

### 5. Modification Example

Hereinafter, description will be given of a modification example of the present technology.

### 5-1. Modification Example Related to Control System

Description has been given of an example in which the whole processing is performed by the information processing terminal 1, but another device may be allowed to perform a part (for example, recognition of the user's action, and the setting processing of the image capture parameters) of the processing.

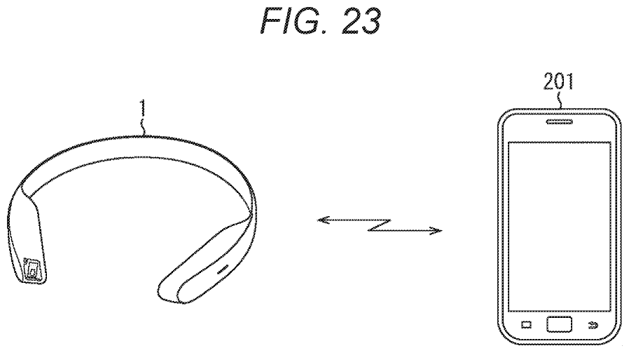

FIG. 23 is a view illustrating an example of a control system.

The control system in FIG. 23 includes the information processing terminal 1 and a portable terminal 201. The portable terminal 201 is a terminal such as a smartphone that is carried by a user who wears the information processing terminal 1. The information processing terminal 1 and the portable terminal 201 are connected to each other through radio communication such as Bluetooth (registered trademark) and Wi-Fi.

The information processing terminal 1 transmits sensor data indicating detection results of respective sensors in image-capturing to the portable terminal 201. The portable terminal 201, which receives the sensor data transmitted from the information processing terminal 1, performs recognition of a user's action on the basis of the sensor data, and transmits information indicating the recognition result to the information processing terminal 1.

The information processing terminal 1 receives the information transmitted from the portable terminal 201, controls the image capture parameters on the basis of the user's action recognized by the portable terminal 201, and performs image-capturing.

In this case, a configuration having a similar function as in the action recognition unit 131 in FIG. 12 is realized in the portable terminal 201. In addition, the image capture control unit 132 in FIG. 12 is realized in the information processing terminal 1.

As described above, a device other than the information processing terminal 1 may be allowed to perform at least a part of the processing. The portable terminal 201 may perform not only the action recognition, but also the processing up to setting of the image capture parameter corresponding to the recognition result.

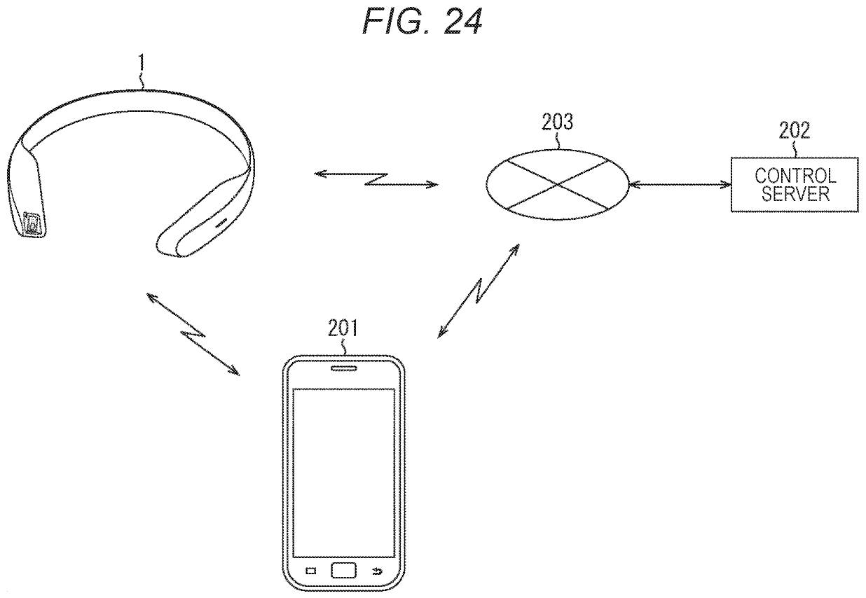

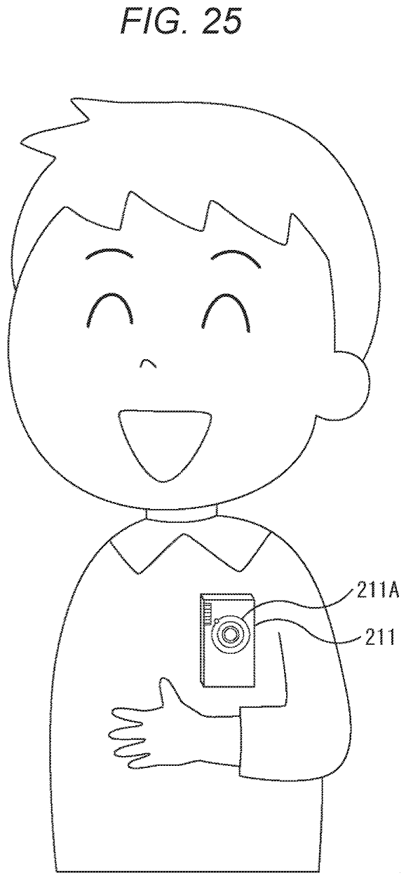

FIG. 24 is a view illustrating another example of the control system.

The control system in FIG. 24 includes the information processing terminal 1, the portable terminal 201, and a control server 202. The portable terminal 201 and the control server 202 are connected to each other through a network 203 such as the Internet.

In a case where the portable terminal 201 is provided with a so-called tethering function, the information processing terminal 1 may be connected to the network 203 through the portable terminal 201. In this case, transmission and reception of information between the information processing terminal 1 and the control server 202 are performed through the portable terminal 201 and the network 203.

In a similar manner to the description made with reference to FIG. 23, the information processing terminal 1 transmits sensor data indicating detection results of respective sensors in image-capturing to the control server 202. The control server 202, which receives the sensor data transmitted from the information processing terminal 1, performs recognition of a user's action on the basis of the sensor data, and transmits information indicating a recognition result to the information processing terminal 1.

The information processing terminal 1 receives information transmitted from the control server 202, controls the image capture parameters on the basis of the user's action recognized by the control server 202, and performs image-capturing.

In this case, a configuration having a similar function as in the action recognition unit 131 in FIG. 12 is realized in the control server 202. In addition, the image capture control unit 132 in FIG. 12 is realized in the information processing terminal 1.

As described above, a device that is connected through the network 203 may be allowed to perform at least a part of the processing. The control server 202 may perform not only the action recognition, but also the processing up to setting of the image capture parameter corresponding to the recognition result.

### 5-2. Modification Example Related to Action Recognition

Classification of the user's actions is not limited to the above-described example, and the number of classifications may be increased or decreased in a recognizable range. For example, not only an action on the ground, but also an action in the water (for example, swimming, diving, and the like), and an action in the air (for example, skydiving, and the like) may be recognized.

In addition, for example, the user's actions may be recognized after being classified in more detail in correspondence with a user's state, a surrounding environment, and the like. For example, the user's actions may be recognized after being classified in more detail on the basis of a movement speed of the user, a posture of the user, a type of an automobile or bicycle on which the user rides, a location in travel, weather, a temperature, and the like, and other image capture parameters may be set as necessary.

For example, each action in a case of “drive”, “touring”, or “cycling” in which the user rides on a predetermined transport may be classified into two types on the basis of whether or not an advancing direction of the user is captured. In addition, in a case where the advancing direction of the user is not captured, as illustrated in the example of FIG. 16, the image capture parameters are set, and in a case where the advancing direction of the user is captured, the image capture parameters may be set to other values. For example, in a case where the advancing direction of the user is captured, the shutter speed may be set to “normal” or “slow”, and the sensitivity may be set to “normal” or “low”. That is, in a case where the movement speed of the user is intermediate or greater, and the vibration is intermediate or less, when the advancing direction of the user is captured, the shutter speed is set to be slower and the sensitivity is set to be lower in comparison to a case where the advancing direction is not captured. According to this configuration, it is possible to capture right and left scenes in a flowing manner while capturing a front direction (advancing direction) of the user without shake. Accordingly, it is possible to obtain an image with realistic feeling a high artistic quality.

In addition, for example, the action recognition unit 131 may recognize the user's action after classification according to a range of values of various pieces of sensor data and the like without recognizing the user's action according to a specific action. For example, the action recognition unit 131 may recognize the user's action as a state in which the user moves at a speed of less than 4 km/h, a state in which the user moves at a speed of 4 km/h or greater, and the like.

In addition, the action recognition method is not limited to the above-described example, and may be changed in an arbitrary manner.

Example Using Position Information

For example, the action recognition unit 131 may perform recognition of a user's action on the basis of position information detected by the signal processing circuit 113 as the GNSS sensor. In this case, the information for action recognition which is provided in the action recognition unit 131 includes, for example, information in which position information and a user's action are correlated with each other.

For example, in the information for action recognition, position information of a park can be correlated with “running” among the user's actions. Position information of a home can be correlated with “stopping” among the user's actions. Position information on a road between a home and a nearby station can be correlated with “walking” among the user's actions.

The action recognition unit 131 recognizes an action correlated with a measured current position in the information for action recognition as a current user's action. According to this configuration, the information processing terminal 1 can recognize a user's action by measuring a current position.

Example Using Information of a Connection Destination

In addition, for example, the action recognition unit 131 may perform recognition of the user's action on the basis of a device that is a connection destination of radio communication. In this case, the information for action recognition which is provided in the action recognition unit 131 includes, for example, information in which device identification information of a device that is a connection destination and the user's action are correlated with each other.

For example, in the information for action recognition, identification information of an access point provided in a park can be correlated with “running” among the user's actions. Identification information of an access point provided in a home can be correlated with “stopping” among the user's actions. Identification information of an access point provided between a home and a nearby station can be correlated with “walking” among the user's actions.

The radio communication module 103 periodically retrieves a device that becomes a connection destination of radio communication such as Wi-Fi. The action recognition unit 131 recognizes an action, which is correlated with a device that becomes a connection destination in the information for action recognition, as a current user's action. According to this configuration, the information processing terminal 1 can recognize a user's action by retrieving a device that becomes a connection destination.

Example Using Information of a Nearby Device

As described above, the information processing terminal 1 includes the built-in NFC tag 105, and can perform short-range radio communication with a nearby device. Here, the action recognition unit 131 may perform recognition of a user's action on the basis of a nearby device before performing image-capturing. In this case, the information for action recognition which is provided in the action recognition unit 131 includes, for example, information in which identification information of a nearby device and a user's action are correlated with each other.

For example, in the information for action recognition, identification information of an NFC tag that is built in a bicycle can be correlated with “cycling” among the user's actions. Identification information of an NFC tag that is built in a chair in a home can be correlated with “stopping” among the user's actions. Identification information of an NFC tag that is built in running shoes can be correlated with “running” among the user's actions.

For example, before riding on a bicycle while wearing the information processing terminal 1, a user approaches the information processing terminal 1 to an NFC tag that is built in the bicycle. In a case where the action recognition unit 131 detects approaching to the NFC tag of the bicycle, the action recognition unit 131 recognizes a users' action as riding on the bicycle after the detection.

In addition, for example, the action recognition unit 131 may perform machine learning of a user's action by using sensor data and the like without using the information for action recognition, and may recognize the user's action on the basis of a model that is generated.

In addition, the sensor data that is used in the action recognition may be changed in an arbitrary manner.

### 5-3. Modification Example Related to Image Capture Mode and Image Capture Parameters

The types of the image capture modes (including detail modes) and the image capture parameters are not limited to the above-described examples, and can be increased or decreased in correspondence with the necessity.

For example, in a case where still images obtained through continuous shooting at low sensitivity are composed to obtain a high image quality, it is possible to control the number of composition sheets of the still images in correspondence with a user's action. In addition, for example, the number of composition sheets of the still images may be controlled in correspondence with a movement speed of a user, a vibration amount, and the like.

In addition, the kind (the number of levels) of the setting values of respective image capture parameters is not limited to the above-described example, and may be increased or decreased in correspondence with the necessity.

In addition, even in the same user's action that is recognized, the image capture parameters can be changed in accordance with conditions different from each other. For example, the shutter speed may be adjusted in correspondence with a movement speed of the user and a vibration amount. In addition, the amount of camera shake correction may be adjusted in correspondence with a vibration amount of the user or the like.

In addition, the interval image capture mode or the auto image capture mode, and the moving image capture mode may be combined with each other. For example, a frame rate may be raised for a predetermined period at a predetermined interval during capturing of a moving image, or the frame rate may be raised for a predetermined period when a predetermined condition is satisfied.

In addition, the image capture parameter may be optimized for every user by using machine learning and the like. For example, the image capture parameters may be optimized in correspondence with a physique, a posture, an action pattern, and taste of the user, amounting position, and the like.

In addition, a plurality of the information processing terminals 1 may control the image capture modes or the image capture parameters in cooperation with each other. For example, in a case where a plurality of users who carry the information processing terminal 1 take an action in combination (for example, in a case of performing touring, cycling, running, and the like in combination), the respective information processing terminals 1 may set the image capture parameters to different values or set different image capture modes in cooperation with each other. According to this configuration, in the respective information processing terminals 1, images according to different image capture modes or image capture parameters can be acquired. In addition, when the acquired images are shared between users, it is possible to enjoy a variety of images in comparison to a case of using only one information processing terminal 1. In addition, when image-capturing is shared by the plurality of information processing terminals 1, it is possible to reduce power consumption of the respective information processing terminals 1.

In addition, the information processing terminal 1 may cooperate with a device other than the information processing terminal 1. For example, the information processing terminal 1 may cooperate with an automobile or a bicycle on which the user rides. Specifically, for example, the sensor data may be acquired from a sensor (for example, a speed sensor, and the like) provided in the automobile or the bicycle instead of a sensor of the information processing terminal 1. According to this configuration, it is possible to reduce power consumption of the information processing terminal 1 or it is possible to acquire sensor data with higher accuracy.

In addition, in a case where the user acts with another human being, an animal (for example, a pet), or the like, the action recognition unit 131 may recognize an action of the human being or the animal which acts with the user in addition to the user's action, and may control the image capture modes or the image capture parameters in correspondence with an action of the human being or the animal which acts with the user.

In addition, the user of the information processing terminal 1 is not necessary to be limited to a human being, and may include an animal. In addition, a method of controlling the image capture modes and the image capture parameter may be changed between a case where the information processing terminal 1 is mounted on a human being and a case where the information processing terminal 1 is mounted on an animal in consideration of a case where the information processing terminal 1 is mounted on the animal such as a pet.

In addition, for example, the information processing terminal 1 may be mounted on a pet such as a dog, and an owner of the pet, and the respective information processing terminals 1 may be cooperated with each other. For example, the information processing terminal 1 mounted on the pet is allowed to operate in the auto image capture mode, and the information processing terminal 1 on the owner side may perform image-capturing in synchronization with image-capturing in the exciting mode by the information processing terminal 1 on the pet side. According to this configuration, for example, the owner can easily understand what the pet is interested in.

Furthermore, the above-described configuration is applicable to not only the pet and the owner, but also human beings. For example, the information processing terminal 1 mounted on a user A is allowed to operate in the auto image capture mode, and the information processing terminal 1 on a user B side may perform image-capturing in synchronization with image-capturing in the exciting mode by the information processing terminal 1 on the user A side. According to this configuration, for example, the user B can easily understand what the user A is interested in or impressed with.

In addition, in a case where a plurality of still images are automatically captured as in the interval image capture mode and the auto image capture mode, an image size and resolution are set to be lower in comparison to the still image capture mode and the still image continuous shooting mode, such that it is possible to reduce capacity per sheet, and it is possible to increase the number of sheets of image-capturing.

In addition, particularly, in capturing moving image, in a case where the image capture parameters rapidly vary or changing of the image capture parameters is frequently performed along with a variation of an action recognition result, there is a concern that an image becomes indistinct. Examples of this situation include a case where if a user stops during cycling, an action is recognized as stopping, and thus the image capture parameters rapidly vary, a case where if the user moves at a speed that is close to a boundary between running and walking, results of action recognition are frequently changed between running and walking, and the like. To prevent the above-described situations, for example, the image capture parameters may be changed after an action after variation continues for a predetermined time with a little time margin until determining change of a recognition result of a user's action. In addition, for example, after a variation of the action recognition result, the image capture parameters may be gradually changed step by step. In addition, for example, in a case where the action recognition result varies, an effect such as scene changing may be carried out in order for a human being who sees an image not to be aware of a variation of the image capture parameters.

In addition, a user may be allowed to appropriately change the image capture parameters. In this case, the image capture parameters may be changed with a voice.

In addition, the user may be allowed to set an initial value of the image capture modes or an initial value of the image capture parameters.

In addition, the information processing terminal 1 may be allowed to give a notification of a current image capture mode or image capture parameter with a voice, such that the user can easily confirm the content of current setting.

In addition, the image capture prohibiting conditions are not limited to the above-described conditions, and can be changed in an arbitrary manner. For example, the information processing terminal 1 may recognize an action or a situation which is necessary to consider privacy of a nearby person, and the like, and may prohibit image-capturing. For example, the information processing terminal 1 may be allowed to recognize a state in which a user rides on public transport facilities other than a train as an action of the user, and in a case where a recognition result of a user's action is “in riding on public transport facilities”, image-capturing may be prohibited. In addition, for example, even in riding on the public transport facilities, in a case where a person does not exist in surrounding, image-capturing may be permitted. In addition, for example, in a case where the information processing terminal 1 detects that the user exists at a location at which a lot of persons gather or image-capturing is prohibited on the basis of position information detected by using the GNSS sensor and the like, image-capturing may be prohibited. In addition, for example, the information processing terminal 1 may perform recognition of a person by using an image obtained through image-capturing, and may prohibit image-capturing in a case where a person is captured at a size equal to or greater than a predetermined size. In addition, for example, in a case where a recognition error occurs, image-capturing may be continued in correspondence with an action recognition result before the recognition error occurs without prohibiting image-capturing.

In addition, the information processing terminal 1 may record an image capture mode or an image capture parameter as metadata of an image. In addition, the information processing terminal 1 may record a recognition result of a user's action, sensor data, and the like as metadata. In addition, for example, the information processing terminal 1 may acquire various parameters of a device (for example, an automobile, a bicycle, and the like) that is used in the user's action, and may record the parameters as metadata.

In addition, description has been given of an example in which the camera cover 51 is set to “open” except for an image capture interruption period during the interval image-capturing and the auto image-capturing. However, for example, the camera may be accommodated whenever image-capturing is terminated, or in a case where a period for which image-capturing is not performed is greater than a predetermined time, and the camera cover 51 may be set to “open” before initiating image-capturing at an image capture timing.

### 5-4. Modification Example Related to Terminal Shape

Example of a Mounting Position

Description has been given on the assumption that the information processing terminal 1 is a neck hanging-type wearable terminal, but the above-described technology is also applicable to wearable terminals which include a camera and have another shape.

FIG. 25 is a view illustrating an example of an information processing terminal having another shape.

A portable terminal 211 in FIG. 25 is a wearable terminal that can be mounted at an arbitrary position of a user's body or cloth by using a clip, a badge, a button, a tie pin, and the like which are provided on a rear surface of a casing, and the like. In the example of FIG. 25, the portable terminal 211 is mounted at a position near a user's breast. A camera 211A is provided on a front surface of the casing of the portable terminal 211.

In addition, the portable terminal 211 may be mounted at other positions such as a wrist and an ankle. The image capture parameter control function and the like are also applicable to a terminal that is mounted on a portion around a shoulder, a waist, and the like which are under the head and in which a posture of the terminal is mainly determined by a posture of the upper half of the body of the user.

In this case, a method of controlling the image capture modes and the image capture parameters can be changed in accordance with a mounting position. Furthermore, for example, in a case where an image capture unit and a control unit that performs control of the image capture parameters are accommodated in housings different from each other, and are provided to be spaced away from each other, the method of controlling the image capture modes and the image capture parameters can be changed on the basis of a mounting position of the image capture unit.

In addition, the information processing terminal 1 or the portable terminal 211 may be used in a state of being mounted on a mount that is attached on a dashboard of an automobile, or a mount attached to a handle of a bicycle. In this case, the information processing terminal 1 or the portable terminal 211 may be used as a so-called drive recorder or an obstacle sensor.

Example Applied to Camera Platform

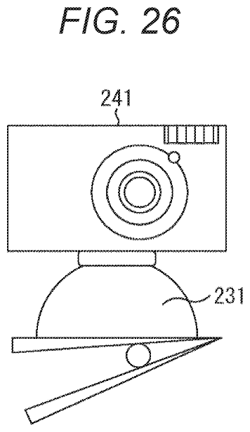

FIG. 26 is a view illustrating an example of a camera platform as an information processing terminal.

A camera platform 231 is a camera platform that can be mounted on a user's body by a clip and the like. A user mounts the camera platform 231, on which a camera 241 is placed, at a predetermined position such as abreast, a shoulder, a wrist, and an ankle. The camera platform 231 and the camera 241 can perform communication in a wireless manner or in a wired manner.

In addition to sensors which detect sensor data used in recognition of a user's action, an application processor is built in the camera platform 231. The application processor of the camera platform 231 executes a predetermined program to realize the functions described with reference to FIG. 12.

That is, the camera platform 231 recognizes a user's action in image-capturing on the basis of sensor data, and controls image capture parameters of the camera 241 in correspondence with the recognition result.

As described above, the above-described image capture parameter control function is also applicable to devices such as the camera platform that is not provided with an image capture function.

In addition, for example, the present technology is also applicable to wearable terminals such as an eyeglass type, a head band type, a pendant type, a ring type, a contact lens type, a shoulder mounting type, and a head mount display. In addition, for example, the present technology is also applicable to an information processing terminal that is embedded in a body.

### 5-5. Other Modification Examples

Description has been given of an example in which the camera block is provided in the right unit 12, but the camera block may be provided in the left unit 13 or on both sides. In addition, the lens 31 may be provided in a state of facing a lateral direction instead of facing a front side.

In addition, the right unit 12 and the left unit 13 may be detachably attached to the band unit 11. A user selects the band unit 11 having a length conforming to a length around a neck of the user, and attaches the right unit 12 and the left unit 13 to the band unit 11 to construct the information processing terminal 1.

In addition, an angle adjustment direction of the camera module 52 may be set to a roll direction, a pitch direction, or a yaw direction.

In addition, as described above, the cover 21 that is inserted into the opening 12A forms a curved surface. Accordingly, there is a possibility that an image capture quality in the vicinity of an edge of an image captured by the camera module 52 has lower resolution in comparison to image capture quality in the vicinity of the center, or deformation may occur in a subject.

Here, image processing may be performed with respect to the image that is captured to prevent such partial image capture quality deterioration. Characteristics of the cover 21 or the lens 31 may be changed in correspondence with a position to optically prevent the partial image capture quality deterioration. In addition, characteristics of the imaging element 52A may be changed, as a case where a pixel pitch of the imaging element 52A in the camera module 52 varies between a position near the center and a position near an edge in the imaging element 52A.

### 6. Others

### 6-1. Configuration Example of Computer

The above-described series of processing may be executed by hardware or software. In a case of executing the series of processing by software, a program that constitutes the software is installed in a computer provided with exclusive hardware, general-purpose personal computer, and the like from a program recording medium.

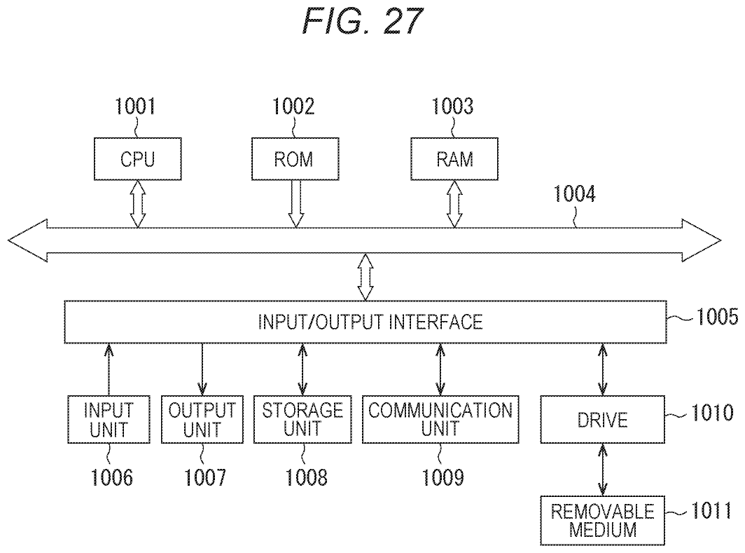

FIG. 27 is a block diagram illustrating a configuration example of computer hardware that executes the above-described series of processing by program.

A CPU 1001, a ROM 1002, and a RAM 1003 are connected to each other by a bus 1004.

An input/output interface 1005 is further connected to the bus 1004. An input unit 1006 including a keyboard, a mouse, a microphone, and the like, and an output unit 1007 including a display, a speaker, and the like are connected to the input/output interface 1005. In addition, a storage unit 1008 including a hard disk, a non-volatile memory, and the like, a communication unit 1009 including a network interface and the like, and a drive 1010 that drives removable medium 1011 are connected to the input/output interface 1005.

In the computer having the above-described configuration, the CPU 1001 loads a program stored, for example, in the storage unit 1008 into the RAM 1003 through the input/output interface 1005 and the bus 1004 and executes the program, whereby the above-described series of processing is performed.

The program that is executed by the CPU 1001 is recorded in the removable medium 1011, or is provided, for example, through a wired or wireless transmission medium such as a local area network, the Internet, and digital satellite broadcasting, and is installed in the storage unit 1008.

Furthermore, the program that is executed by the computer may be a program in which processing is performed in time-series according to the procedure described in this specification, or may be a program in which processing is performed in parallel or at a necessary timing such as when a call is made. In addition, a plurality of the computers may perform the above-described processing in cooperation with each other. A computer system is constituted by a single computer or a plurality of computers which perform the above-described processing.

In addition, in this specification, the system represents an assembly of a plurality of constituent elements (apparatuses, modules (parts), and the like), and whether or not the entirety of the constituent elements exist in the same casing does not matter. Accordingly, both of a plurality of apparatuses which are accommodated in individual casings and are connected through a network, and one apparatus in which a plurality of modules are accommodated in one casing represent the system.

In addition, an embodiment of the present technology is not limited to the above-described embodiment, and various modifications can be made in a range not departing from the gist of the present technology.

For example, the present technology can have a cloud computing configuration in which one function is shared by a plurality of apparatuses and is processed in cooperation through a network.

In addition, the respective steps described in the flowchart can be executed in a state of being shared by a plurality of apparatuses in addition to execution by one apparatus.

In addition, in a case where a plurality of kinds of processing are included in one step, the plurality of kinds of processing included in one step can be executed in a state of being shared by a plurality of apparatuses in addition to execution by one apparatus.

### 6-2. Composition Example of Configuration

The present technology can employ the following configurations.

(1)

An information processing apparatus, including:

an image capture control unit that controls an image capture parameter of an image capture unit mounted on a user on the basis of a recognition result of an action of the user.

(2)

The information processing apparatus according to (1),

in which the image capture parameter includes at least one of a parameter related to an operation of an imaging element of the image capture unit, and a parameter related to processing of a signal from the imaging element.

(3)

The information processing apparatus according to (2),

in which the parameter related to the operation of the imaging element includes at least one of a shutter speed or an image capture timing, and the parameter related to processing of the signal from the imaging element includes at least one of sensitivity or a camera shake correction range.

(4)

The information processing apparatus according to (3),

in which the image capture control unit controls at least one of the shutter speed, the sensitivity, or the camera shake correction range on the basis of a movement speed of the user and vibration.

(5)

The information processing apparatus according to (3) or (4),

in which in a case where the user rides on a predetermined transport, the image capture control unit makes the shutter speed slower and makes the sensitivity lower when capturing an advancing direction, in comparison to a case where the advancing direction is not captured.

(6)

The information processing apparatus according to any one of (3) to (5),

in which the image capture control unit controls the shutter speed and the sensitivity when capturing a still image, and controls the sensitivity and the camera shake correction range when capturing a moving image.

(7)

The information processing apparatus according to any one of (3) to (6),

in which the image capture control unit performs control so that image-capturing is performed in a case where the user takes a predetermined action.

(8)

The information processing apparatus according to any one of (3) to (7),

in which the image capture control unit controls an image capture timing on the basis of biological information of the user.

(9)

The information processing apparatus according to any one of (1) to (8),

in which the image capture control unit switches a state in which a lens of the image capture unit is seen from the outside and a state in which the lens is not seen from the outside on the basis of the recognition result of the action of the user.

(10)

The information processing apparatus according to any one of (1) to (9),

in which the image capture control unit performs control so that image-capturing is performed at an interval based on at least one of time, a movement distance of the user, or an altitude of a location of the user.

(11)

The information processing apparatus according to (10),

in which the image capture control unit selects whether to perform image-capturing at an interval based on the time or to perform image-capturing at an interval based on the movement distance of the user on the basis of a movement speed of the user.

(12)

The information processing apparatus according to any one of (1) to (11),

in which the image capture control unit controls the image capture parameter in cooperation with another information processing apparatus.

(13)

The information processing apparatus according to any one of (1) to (12),

in which the image capture control unit changes a method of controlling the image capture parameter in accordance with a mounting position of the image capture unit.

(14)

The information processing apparatus according to any one of (1) to (13),

in which in a case where the action of the user varies, the image capture control unit changes the image capture parameter after the action of the user after variation continues for a predetermined time.

(15)

The information processing apparatus according to any one of (1) to (14),

in which in a case where the action of the user varies, the image capture control unit changes the image capture parameter step by step.

(16)

The information processing apparatus according to any one of (1) to (15),

in which the image capture control unit controls the image capture parameter on the basis of a surrounding environment.

(17)

The information processing apparatus according to any one of (1) to (16),

in which the action of the user that is recognized includes at least one of in riding in a car, in riding on a motorbike, in riding on a bicycle, in running, in walking, in riding on a train, and in stopping.

(18)

The information processing apparatus according to any one of (1) to (17):

in which the action recognition unit further includes an action recognition unit that recognizes the action of the user on the basis of one or more of detection results of a current position, a movement speed, vibration, and a posture of the user.

(19)

An information processing method, including:

an image capture control step of controlling image capture parameter of an image capture unit mounted on a user by an information processing apparatus on the basis of a recognition result of an action of the user.

(20)

A program that allows a computer to execute:

an image capture control step of controlling image capture parameter of an image capture unit mounted on a user on the basis of a recognition result of an action of the user.

(21) The information processing apparatus according to any one of (3) to (8),

in which the image capture control unit performs control so that image-capturing is performed in a case where a current position of the user is a predetermined location.

(22) The information processing apparatus according to any one of (3) to (8),

in which the image capture control unit performs control so that image-capturing is performed in a case where a predetermined keyword of voice is detected.

(23) The information processing apparatus according to according to any one of (3) to (8),

in which the image capture control unit performs control so that image-capturing is performed in a case where a variation of a scene is detected.

(24) The information processing apparatus according to (9),

in which in a case where the user takes an action which is necessary to consider privacy of a nearby person, the image capture control unit sets a lens of the image capture unit to a state of not being seen from the outside.

(25) The information processing apparatus according to (12),

in which the image capture control unit sets the image capture parameter to values different from values in the other information processing apparatus in cooperation.

(26) The information processing apparatus according to any one of (1) to (18),

in which the image capture control unit controls the image capture parameter on the basis of an action recognition result of a human being or an animal which acts in combination with the user.

(27) The information processing apparatus according to any one of (1) to (18),

in which the user includes an animal, and

the image capture control unit changes a method of controlling the image capture parameter between a case where the image capture unit is mounted on a human being and a case where the image capture unit is mounted on an animal.

(28) The information processing apparatus according to any one of (1) to (18), further including:

the image capture unit.

### REFERENCE SIGNS LIST

1 Information processing terminal
31 Lens
51 Camera cover
52 Camera module
101 Application processor
113 Signal processing circuit
114 GNSS antenna
116 Microphone
117 Sensor module
131 Action recognition unit
132 Image capture control unit
201 Portable terminal
202 Control server
211A Camera
231 Camera platform
241 Camera

1. An information processing apparatus, comprising:
an image capture control unit that controls an image capture parameter of an image capture unit mounted on a user on the basis of a recognition result of an action of the user.

2. The information processing apparatus according to claim 1,
wherein the image capture parameter includes at least one of a parameter related to an operation of an imaging element of the image capture unit, and a parameter related to processing of a signal from the imaging element.

3. The information processing apparatus according to claim 2,
wherein the parameter related to the operation of the imaging element includes at least one of a shutter speed or an image capture timing, and the parameter related to processing of the signal from the imaging element includes at least one of sensitivity or a camera shake correction range.

4. The information processing apparatus according to claim 3,
wherein the image capture control unit controls at least one of the shutter speed, the sensitivity, or the camera shake correction range on the basis of a movement speed of the user and vibration.

5. The information processing apparatus according to claim 3,
wherein in a case where the user rides on a predetermined transport, the image capture control unit makes the shutter speed slower and makes the sensitivity lower when capturing an advancing direction, in comparison to a case where the advancing direction is not captured.

6. The information processing apparatus according to claim 3,
wherein the image capture control unit controls the shutter speed and the sensitivity when capturing a still image, and controls the sensitivity and the camera shake correction range when capturing a moving image.

7. The information processing apparatus according to claim 3,
wherein the image capture control unit performs control so that image-capturing is performed in a case where the user takes a predetermined action.

8. The information processing apparatus according to claim 3,
wherein the image capture control unit controls an image capture timing on the basis of biological information of the user.

9. The information processing apparatus according to claim 1,
wherein the image capture control unit switches a state in which a lens of the image capture unit is seen from the outside and a state in which the lens is not seen from the outside on the basis of the recognition result of the action of the user.

10. The information processing apparatus according to claim 1,
wherein the image capture control unit performs control so that image-capturing is performed at an interval based on at least one of time, a movement distance of the user, or an altitude of a location of the user.

11. The information processing apparatus according to claim 10,
wherein the image capture control unit selects whether to perform image-capturing at an interval based on the time or to perform image-capturing at an interval based on the movement distance of the user on the basis of a movement speed of the user.

12. The information processing apparatus according to claim 1,
wherein the image capture control unit controls the image capture parameter in cooperation with another information processing apparatus.

13. The information processing apparatus according to claim 1,
wherein the image capture control unit changes a method of controlling the image capture parameter in accordance with a mounting position of the image capture unit.

14. The information processing apparatus according to claim 1,
wherein in a case where the action of the user varies, the image capture control unit changes the image capture parameter after the action of the user after variation continues for a predetermined time.

15. The information processing apparatus according to claim 1,
wherein in a case where the action of the user varies, the image capture control unit changes the image capture parameter step by step.

16. The information processing apparatus according to claim 1,
wherein the image capture control unit controls the image capture parameter on the basis of a surrounding environment.

17. The information processing apparatus according to claim 1,
wherein the action of the user that is recognized includes at least one of in riding in a car, in riding on a motorbike, in riding on a bicycle, in running, in walking, in riding on a train, and in stopping.

18. The information processing apparatus according to claim 1, further comprising:
an action recognition unit that recognizes the action of the user on the basis of one or more of detection results of a current position, a movement speed, vibration, and a posture of the user.

19. An information processing method, comprising:
an image capture control step of controlling image capture parameter of an image capture unit mounted on a user by an information processing apparatus on the basis of a recognition result of an action of the user.

20. A program that allows a computer to execute:
an image capture control step of controlling image capture parameter of an image capture unit mounted on a user on the basis of a recognition result of an action of the user.
